(19) United States
(12) Patent Application Publication
(10) Pub. No.: US 2002/0147935 A1
(43) Pub. Date: Oct. 10, 2002

(54) Timer circuit

(75) Inventor: Takashi Miyake, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 09/942,587

(22) Filed: Aug. 31, 2001

(30) Foreign Application Priority Data
Apr. 4, 2001 (JP) 2001-106429

(51) Int. Cl. G06F 1/04; G06F 1/06; G06F 1/08

(52) U.S. Cl. 713/500

(57) ABSTRACT

When the counter sequentially carries out a count operation during a first count period and a subsequent second count period, the correction value write controller writes a correction value into a correction register in response to a correction execution post signal. The correction timing register generates and outputs a signal for assigning a count period to be corrected. The count period controller outputs a signal that indicates operation status of the counter. When the count period indicated by the signal for assigning a count period to be corrected coincides with the count period indicated by the signal that indicates operation status of the counter, the correction value write controller provides a control to input the correction value written in the correction register into the adder circuit. This correction value is set to the counter thereby correcting the count period.

### FIELD OF THE INVENTION

The present invention relates to a timer circuit having various clock operation modes, and capable of correcting a count period during the count operation.

### BACKGROUND OF THE INVENTION

In timer circuits having various kinds of clock modes like one-shot output or delayed one-shot output, it is possible to correct the count period during the count operation. In other words, the timer circuit is able to carry out a correction operation for changing the count period to a new count period while the count operation is being performed. A conventional timer circuit will be explained below with reference to FIG. 30 to FIG. 40.

FIG. 30 shows an example of structure of a conventional timer circuit. FIG. 31 shows an example of structure of a clock generator. FIG. 32 is a concept diagram showing an internal structure of the F/F 302. FIG. 33 shows a detailed structure example of the count period controller 119 shown in FIG. 30. FIG. 34 shows a detailed structure example of the correction value write controller 123 shown in FIG. 30. FIG. 35 shows a detailed structure example of the counter value write controller 125 shown in FIG. 30. FIG. 36 shows a detailed structure example of the reload value write controller 126 shown in FIG. 30. FIG. 37 shows a detailed structure example of the output signal generator 121 shown in FIG. 30. FIG. 38 shows a time chart for explaining a delayed one-shot operation mode. FIG. 39 and FIG. 40 are time charts for explaining a correction operation for correcting mainly the count period.

FIG. 30 shows a timer circuit having a 16-bit counter. As shown in FIG. 30, the data bus 100 is connected with the correction register 102 via the switch circuit (“SW”) 101, the counter WR buffer 104 via the SW 103, and the reload register 106 via the SW 105, respectively.

An output of the correction register 102 is input to a correction register latch 108 via the SW 107, and an output of the correction register latch 108 is input to one input of the adder circuit 110. An input for executing a normal count operation (a count down) is given to the same one input of this adder circuit 110 via the SW 111. The other input of the adder circuit 110 is provided with a counter value from a counter latch that holds this value. An output of the adder circuit 110 is input to the counter 116 via the switches (“SWs”) 114 and 115.

An output of the counter WR 104 is input to the counter 116 via the SW 117. An output of the reload register 106 is input to the counter 116 via SW 118 and SW 115. An output of the counter 116 is directly input to the count period controller 119, and is also input to the counter latch 113 via the SW 120. A timer clock Tim_CLK is applied to the SW 107 and SW 120 respectively as an ON/OFF control signal from the outside.

The count period controller 119 generates a reload control signal RLD, an underflow signal UDF, and a stop signal dis, based on an operation clock dev_CLK, a source count clock INCLK, and a correction execute signal REV_ACT that are input from the outside. The underflow signal UDF is applied to an output signal generator 121, and the stop signal dis is output to the outside. The reload control signal RLD directly becomes an ON/OFF control signal of the SW 118, and also becomes an ON/OFF control signal of the SW 114 via an inverter 122. Detailed contents of the count period controller 119 will be explained later with reference to FIG. 33.

The output signal generator 121 consists of a T flip-flop, and the output signal generator 121 reads the underflow signal UDF that is input with an interval, by an operation clock dev_CLK that is input from the outside, in the delayed one-shot operation mode. The output signal generator 121 then generates an output signal TO that shows a one-shot period after a delay. An initialize signal INI is input to the output signal generator 121 from the outside. Detailed contents of the output signal generator 121 will be explained later with reference to FIG. 37.

The correction value write controller 123 generates a select signal REV_SEL, a write signal WR_REV_P, and a correction execute signal REV_ACT, based on a correction execution post signal dec_WR_REV, an operation clock dev_CLK, a timer clock Tim_CLK1, and a source count clock INCLK1 that are input from the outside. When a timer stop signal Tim_dis has been input from the outside, the generation of the select signal REV_SEL and the correction execute signal REV_ACT is stopped.

The select signal REV_SEL directly becomes an ON/OFF signal of the SW 109, and also becomes an ON/OFF signal of the SW 111 via an inverter 124. The write signal WR_REV_P directly becomes an ON/OFF signal of the SW 101. The correction execute signal REV_ACT is output to the count period controller 119. Detailed contents of the correction value write controller 123 will be explained later with reference to FIG. 34.

The counter value write controller 125 generates a write signal WR_CT_P, a control signal CT_CLK, and a control signal WR_CT_CLK, based on a count value write request dec_WR_CT, an operation clock dev_CLK, and a timer clock Tim_CLK1 that are input from the outside. The control signal CT_CLK becomes an ON/OFF control signal of the SW 115. The control signal WR_CT_CLK becomes an ON/OFF control signal of the SW 117. Detailed contents of the counter value write controller 125 will be explained later with reference to FIG. 35.

The reload value write controller 126 generates a write signal WR_RLD_P based on a reload value write request dec_WR_RLD and an operation clock dev_CLK that are input from the outside. The write signal WR_RLD_P becomes an ON/OFF control signal of the SW 105. Detailed contents of the reload value write controller 126 will be explained later with reference to FIG. 36.

Detailed structure of each element will be explained next. First, the structure of the clock generator will be explained with reference to FIG. 31. As shown in FIG. 31, the clock generator consists of an AND gate 301, a flip-flop (hereinafter to be abbreviated as an “F/F”) 302, and an AND gate 303.

A source count clock INCLK that is given from the outside is a clock that is generated by an internal clock generator, and this is shown under (2) in FIG. 39 and FIG. 40 respectively. An operation clock signal dev_CLK that is given from the outside is a clock for the circuit operation, and this is shown under (1) in FIG. 39 and FIG. 40 respectively. As shown in these drawings, the operation clock signal dev_CLK is generated having a constant relationship with the source count clock INCLK. The AND gate 301 outputs a timer clock Tim_CLK in synchronism with an “H” timing of the operation clock dev_CLK, from the source count clock INCLK and the operation clock dev_CLK (see (4) in FIG. 39 and FIG. 40 respectively).

The F/F 302 is input with a source count clock INCLK at a data input column D, and is also input with an input of the operation clock signal dev_CLK at a clock input terminal CLK. The F/F 302 outputs the source count clock INCLK1 from an output terminal Q in synchronism with the “H” timing of the operation clock dev_CLK. The AND gate 303 outputs a timer clock Tim_CLK1 in synchronism with an “L” timing of the operation clock dev_CLK, from the source count clock INCLK1 and the operation clock dev_CLK (see (5) in FIG. 39 and FIG. 40 respectively).

FIG. 32 is a concept diagram showing an internal structure of the F/F 302 shown in FIG. 31. In FIG. 32, a data input terminal D is connected to an output terminal Q via a series circuit of two inverters 312 and 313 that constitute a SW 311 and a delay circuit. A SW 314 is connected in parallel to the series circuit of the two inverters 312 and 313. A clock input terminal CLK is connected to a control end of the SW 311, and is also connected to a control end of the SW 314 via the inverter 312.

When the clock input terminal CLK is at the “H” level, the SW 311 carries out the ON operation, and the SW 314 carries out the OFF operation. Therefore, when a signal (INCLK) has been applied to the data input terminal D, the SW 311 carries out the ON operation in synchronism with the “H” timing of the clock (dev_CLK) that is applied to between the click input terminals CLKs. Thus, the input signal (INLK) is read, and the output terminal Q becomes at the “H” level after a lapse of a delay time prescribed by the series circuit of the two inverters 312 and 313. This operation continues during a period while the input signal (INCLK) keeps the “H” level. When the input signal (INCLK) has declined to the “L” level, the output terminal Q becomes at the “L” level in a similar sequence. The source count clock INCLK1 that is delayed by one operation clock dev_CLK from the source count clock INCLK is generated in the manner as described above (see (3) in FIG. 39 and FIG. 40 respectively).

Next, the detailed contents of the count period controller 119 will be explained with reference to FIG. 33. As shown in FIG. 33, the count period controller 119 consists of AND gates 321, 322, 323, and 324, an F/F 325, a T-F/F 326, and an inverter 327.

The AND gate 321 is applied with a counter value of a 16-bit structure of the counter 116. When all the 16 bits are zero, the output to the AND gate 322 becomes at the “H” level. That all the bits of the counter value of the counter 116 have become zero means that the count period has finished. Hereinafter, a 16-bit data structure will be expressed as H “xxxx”.

In the state that the correction execute signal RFV_ACT has not been generated, the AND gate 322 synchronizes a detection timing of a count value H “0000” in the AND gate 321 with the source count clock INCLK. The AND gate 322 outputs an underflow signal UDF (see (17) in FIG. 39 and FIG. 40 respectively). In the state that the correction execute signal RFV_ACT has been generated, the generation of the underflow signal UDF is cancelled. The F/F 325 is input with an underflow signal UDF at a data input terminal D, and is also input with an operation clock dev_CLK at a clock input terminal CLK. The F/F 325 output a signal UDF_D in synchronism with the operation clock dev_CLK from an output terminal Q (see (18) in FIG. 39 and FIG. 40 respectively).

The T-F/F 326 is input with an output (UDF_D) of the F/F 325 at a toggle input terminal T, and is also input with an operation clock dev_CLK at a clock input terminal CLK, via the inverter 327. The T-F/F 326 outputs a signal CNT_UNDF that shows an operation status of the counter 116 from the output terminal Q in synchronism with the “L” timing of the operation clock dev_CLK (see (19) in FIG. 39 and FIG. 40 respectively). FIG. 37 is a concept diagram showing an internal structure of the T-F/F 326 shown in FIG. 33. In FIG. 37, the T-F/F 326 consists of AND gates 361 and 362, SWs 363, 364, 365 and 366, inverters 367, 368, 369, 370 and 371, and an OR gate 372. The T-F/F 326 is reset by a timer stop signal Tim_dis that is input to a reset terminal from the outside. The AND gate 323 outputs an underflow signal UDF when a counter status signal CNT_UDF is at the “L” level, as a reload control signal RLD (see (20) in FIG. 39 and FIG. 40 respectively). The AND gate 324 outputs an underflow signal UDF when the counter status signal CNT_UDF is at the “H” level, as a timer stop signal dis.

Referring back to FIG. 30, before the reload control signal RLD is generated, the SW 114 carries out the ON operation, and operates to send the output of the adder circuit 110 to the counter 116. However, when the reload control signal RLD has been generated by the first underflow signal UDF as described above, the SW 118 carries out the ON operation, and operates to send the reload value of the reload register 106 to the counter 116.

Next, a detailed structure of the correction value write controller 123 will be explained with reference to FIG. 34. As shown in FIG. 34, the correction value write controller 123 consists of flip-flops (“F/Fs”) 331, 332, 333, 334 and 335, AND gates 336, 337 and 338, inverters 339, 340 and 341, and an OR gate 342.

The F/F 331 is input with a correction execution post signal dec_WR_REV (see (9) in FIG. 39 and FIG. 40 respectively) for posting a write occurrence to the correction register 102 at a data input terminal D, and is also input with an operation clock dev_CLK at a clock input terminal CLK via the inverter 339. The F/F 331 outputs the correction execution post signal dec_WR_REV from an output terminal Q to the AND gate 338 as a signal WR_REV in synchronism with the “L” timing of the operation clock dev_CLK (see (10) in FIG. 39 and FIG. 40 respectively). The AND gate 338 generates the output (WR_REV) of the F/F 331 in synchronism with the operation clock dev_CLK as a write signal WR_REV_P. When the write signal WR_REV_P has been generated, the SW 101 in FIG. 30 carries out the ON operation, and a correction value is read from the data bus 100, and is written into the correction register 102 (see (14) in FIG. 39 and FIG. 40 respectively). Thereafter, when the SW 107 carries out the ON operation by the timer clock Tim_CLK, the contents of the correction register 102 are read into the correction register latch 108, and are held there (see (15) in FIG. 39 and FIG. 40 respectively).

The AND gate 336 outputs the correction execution post signal dec_WR_REV to the OR gate 342 in synchronism with the “L” timing of a source count clock INCLK1. The AND gate 337 applies the correction execution post signal dec_WR_REV to a data input terminal D of the F/F 332 in synchronism with the “H” timing of the source count clock INCLK1. The F/F 332 is input with an operation clock dev_CLK at a clock input terminal via the inverter 340, and generates an output of the AND gate 337 from an output terminal Q to a data input terminal D of the F/F 333 in synchronism with the “L” timing of the operation clock dev_CLK. The F/F 333 is input with an operation clock dev_CLK at a clock input terminal, and generates an output of the F/F 332 from an output terminal Q to the OR gate 342 in synchronism with the operation clock dev_CLK.

The OR gate 342 outputs any one of the outputs of the AND gate 336 and the F/F 333 to the F/F 334 as a control signal REV_SET. In other words, when the occurrence timing of the correction execution post signal dec_WR_REV does not overlap with the source count clock INCLK1, the correction execution post signal dec_WR_REV is output straight as the control signal REV_SET (see (11) in FIG. 40). On the other hand, when the occurrence timing of the correction execution post signal dec_WR_REV overlaps with the source count clock INCLK1, the correction execution post signal dec_WR_REV is delayed by one operation clock dev_CLK. This is output as the control signal REV_SET (see (11) in FIG. 39). When the timer stop signal Tim_dis does not exist, the F/F 334 is set in synchronism with the control signal REV_SET and the “H” timing of the operation clock dev_CLK that is input via the inverter 431. The F/F 334 outputs the correction execute signal REV_ACT (see (12) in FIG. 39 and FIG. 40 respectively).

The correction execute signal REV_ACT has been input to the data input terminal D of the F/F 335. The F/F 334 is reset at the “H” timing of the timer clock Tim_CLK1 when the control signal REV_SET is not been generated, or by the input of the timer stop signal Tim_dis. The F/F is input with an operation clock dev_CLK at a clock input terminal CLK, and outputs the correction execute signal REV_ACT in synchronism with the “H” timing of the operation clock dev_CLK as a select signal REV_SEL REV_ACT (see (13) in FIG. 39 and FIG. 40 respectively). When the select signal REV_SEL has been generated, the SW 111 in FIG. 30 carries out the OFF operation, and the SW 109 carries out the ON operation and the correction value held by the correction register latch 108 is read into the adder circuit 110.

Next, a detailed structure of the counter value write controller 125 will be explained with reference to FIG. 35. As shown in FIG. 35, the counter value write controller 125 consists of F/Fs 341 and 342, inverters 343 and 344, and AND gates 345, 346 and 347.

The F/F 341 is input with a write request signal dec_WR_CT for writing to the counter 116 that has been generated at the outside, at a data input terminal D. The F/F 341 is also input with an operation clock dev_CLK at a clock input terminal CLK via the inverter 343. Then, the F/F 341 outputs the write request signal dec_WR_CT from an output terminal Q to a data input terminal D of the F/F 342 and to the AND gate 347 in synchronism with the “L” timing of the operation clock dev_CLK. The AND gate 347 generates an output of the F/F 341 as a write signal WR_CT_P in synchronism with the “H” timing of the operation clock dev_CLK. When the write signal WR_CT_P has been generated, the SW 103 in FIG. 30 carries out the ON operation, and the counter value on the data bus 100 is read and is written into the counter WR buffer 104.

The F/F 342 is input with an operation clock dev_CLK at a clock input terminal CLK, and generates an output of the F/F 341 from an output terminal Q to the AND gates 345 and 346 in synchronism with the “H” timing of the operation clock dev_CLK. The AND gate 345 is input with a timer clock Tim_CLK1, and outputs the timer clock Tim_CLK1 when the output of the F/F 342 is at the “L” level, as a control signal CT_CLK. When the control signal CT_CLK has been generated, the SW 115 in FIG. 30 carries out the ON operation, and the output of the SW 114 (that is, the output of the adder circuit 110) or the output of the SW 118 (that is, the output of the reload register 106) is written into the counter 116.

The AND gate 346 is input with an operation clock dev_CLK via the inverter 344, and generates an output of the F/F 342 in synchronism with the “L” timing of the operation clock dev_CLK, as a control signal WR_CT_CLK. When the control signal WR_CT_CLK has been generated, the control signal CT_CLK is masked, and the SW 117 in FIG. 30 carries out the ON operation, and the count value stored in the counter WR buffer 104 is written into the counter 116.

Next, a detailed structure of the reload value write controller 126 will be explained with reference to FIG. 36. As shown in FIG. 36, the reload value write controller 126 consists of an F/F 351, an inverter 352, and an AND gate 353.

The F/F 351 is input with a write request signal dec_WR_RLD for writing to the reload register 106 that has been generated at the outside, at a data input terminal D. The F/F 351 is also input with an operation clock dev_CLK at a clock input terminal CLK via the inverter 352. Then, the F/F 351 outputs the write request signal dec_WR_RLD from an output terminal Q to the AND gate 353 in synchronism with the “L” timing of the operation clock dev_CLK. The AND gate 353 generates an output of the F/F 351 as a write signal WR_RLD_P in synchronism with the “H” timing of the operation clock dev_CLK. When the write signal WR_RLD_P has been generated, the SW 105 in FIG. 30 carries out the ON operation, and the reload value on the data bus 100 is read and is written into the reload register 106.

Next, a detailed structure of the output signal generator 121 will be explained with reference to FIG. 37. FIG. 37 shows a concept of the internal structure of the T flip-flop as a key part of the output signal generator 121. In FIG. 37, the T flip-flop consists of AND gates 361 and 362, SWs 363, 364, 365 and 366, inverters 367, 368, 369, 370 and 371, and an OR gate 372.

The AND gate 361 reads a signal (UDF) applied to a data input terminal T, in synchronism with the “H” timing of a clock (dev_CLK) applied to a clock input terminal CLK, and sets the output to the “H” level. The output of the AND gate 361 is applied to a control terminal of the SW 363, and is also applied to a control terminal of the SW 364 via the inverter 367. One end of the SW 363 is connected to an output terminal Q via a series circuit of the AND gate 363 and the inverter 362. The SW 364 is connected in parallel to a series circuit of the AND gate 362 and the inverter 368. A connection end of the AND gate 362 and the inverter 368 is connected to one end of the SW 365. The other end of the SW 365 is connected to one end of the SW 366, and is also connected to the other end of the SW 366 and the other end of the SW 363 respectively via a series circuit of the inverter 371 and the OR gate 372. An initialize signal INI is input to the AND gate 362 and the OR gate 372 via the inverter 369.

In the above structure, the SW 363 carries out the ON operation only during a period while the output of the AND gate 361 is at the “H” level. On the other hand, the SW 364 carries out the OFF operation only during a period while the output of the AND gate 361 is at the “L” level. The SW 365 and the SW 366 alternately repeat the ON operation and the OFF operation.

An output end Q is normally at the “H” level. When a first underflow signal UDF has been input to a data input terminal T, the output terminal Q becomes at the “L” level based on the ON operation of the SW 363 and the OFF operation of the SW 364. Thereafter, the SW 365 and the SW 366 alternately repeat the ON operation and the OFF operation, and the “L” level status of the output terminal Q is maintained. Next, when a second underflow signal UDF has been input, the output terminal Q operates to return to the “H” level based on the ON operation of the SW 363 and the OFF operation of the SW 364. When the output status of the output terminal Q is inverted, an output signal TO that shows a one-shot period after a delay is obtained.

Next, the outline operation of the conventional timer circuit having the above structure will be explained. In FIG. 30, first in the normal one-shot operation mode, the select signal REV_SEL is at the “L” level, and the SW 111 carries out the ON operation. A set value (−1(H “FFFF”)) for carrying out the normal operation is applied to the adder circuit 110.

In the counter value write controller 125, the SW 103 carries out the ON operation based on a write signal WR_CT_P, and a counter value on the data bus 100 is read into the counter WR buffer 104. Then, the SW 117 carries out the ON operation based on a control signal WR_CT_CLK, and a counter value of the counter WR buffer 104 is set to the counter 116. Next, the SW 120 carries out the ON operation based on a subsequent timer clock Tim_CLK, and the counter value of the counter 116 is read into the counter latch 113. Then, the adder circuit 110 adds the value of the counter latch 113 to the set value (−1(H “FFFF”)) for carrying out the normal count operation.

In this case, the reload control signal RLD is at the “L” level, and the SW 114 is carrying out the ON operation. Further, a control signal CT_CLK is generated in place of the control signal WR_CT_CLK, and the SW 15 is carrying out the ON operation. Therefore, the output “counter value −1” of the adder circuit 110 is read into the counter 116 via the SWs 114 and 115. As explained above, in the normal one-shot operation mode, the count value is counted down along the occurrence of the timer clocks Tim_CLK and Tim_CLK1.

Next, a delay one-shot operation mode will be explained with reference to FIG. 38. In FIG. 38, a counter set value is a counter value for a delay period that is set in advance to the counter 116 via the counter WR buffer 104 and the SW 117. This value is set based on the generation of a write signal WR_CT_P. A reload register set value is a counter value for a one-shot period after a delay period that is set in advance to the reload register 106. This value is set based on the generation of a write signal WR_RL_P.

When the timer circuit has started operation under a timer enable status, the timer circuit executes a down-count operation based on the counter value. When the counter value of the counter 116 has become H “0000”, a first underflow signal UDF is generated. When a reload control signal RLD has been generated following this underflow signal, the SW 118 carries out the ON operation. As a result, a counter value (hereinafter to be referred to as a “reload value”) for a one-shot period that has been set in advance to the reload register 106 is read into the counter 116.

The counter 116 carries out a down-count operation based on the reload value. When the counter value has become H “0000”, a second underflow signal UDF is generated, and a timer stop signal dis is generated. Thus, the count operation is stopped. The output signal generator 121 outputs a timer signal TO during a period from the first underflow signal UDF to the second underflow signal UDF.

Next, the operation of correcting a count period will be explained with reference to FIG. 39 and FIG. 40. The correction operation for correcting the count period is started when a correction execution post signal dec_WR_REV (see (9) in FIG. 39 and FIG. 40 respectively) is input to the correction value write controller 123.

In other words, a control signal WR_REV (see (10) in FIG. 39 and FIG. 40 respectively) is generated when the correction execution post signal dec_WR_REV has been input. When the write signal WR_REV_P has been generated, the SW 101 carries out the ON operation, and a correction set value is read from the data bus 100 and is written into the correction register 102 (see (14) in FIG. 39 and FIG. 40 respectively) Thereafter, when the SW 107 carries out the ON operation based on a timer clock Tim_CLK, the correction set value of the correction register 102 is written into the correction register latch 108, and is held there (see (15) in FIG. 39 and FIG. 40 respectively). At the same time, when the SW 120 carries out the ON operation based on the timer clock Tim_CLK, the counter value (see (8) in FIG. 39 and FIG. 40 respectively) of the counter 116 is written into the counter latch 113 (see (6) in FIG. 39 and FIG. 40 respectively), and is output to the adder circuit 110. The adder circuit 110 holds this counter value.

On the other hand, the SW 109 carries out the ON operation based on the select signal REV_SEL (see (13) in FIG. 39 and FIG. 40 respectively), and the correction set value of the correction register latch 108 is output to the adder circuit 110. The adder circuit 110 holds this value. As a result, the adder circuit 110 executes the addition of the counter value and the correction set value (see (7) in FIG. 39 and FIG. 40 respectively). In this case, the reload control signal RLD is at the “L” level (see (20) in FIG. 39 and FIG. 40 respectively). Therefore, the SW 114 is carrying out the ON operation.

Therefore, when the control signal CT_CLK is generated from the counter value write controller 125, the SW 115 carries out the ON operation, and the output of the adder circuit 110 is read into the counter 116 (see (8) in FIG. 39 and FIG. 40 respectively). The counter value is replaced with the new counter value. In other words, the correction of the count period is completed. After the completion, the select signal REV_SEL becomes at the “L” level, and the operation returns to the normal count operation based on the corrected counter value.

According to the above-described count period correction operation, there has been a possibility that the correction is executed during an unintended count period. For example, there has been a possibility that although a set value of the counter WR buffer 104 should be corrected, a set value of the reload register 106 is corrected.

Therefore, conventionally, in the timing signal output operation based on two or more set values like the set value of the counter WR buffer 104 and the set value of the reload register 106 in the delayed one-shot mode, the operation has been carried out as follows. For executing the correction in the middle of this output operation, the status of the output signal TO is confirmed, and the current operation status of the counter is read. Then, it is confirmed whether the read operation status of the counter shows that the counter is in the operation during which period the correction has been executed or not. When it is the timing for executing the correction, the correction is executed (the writing to the correction register is executed) The correction execution post signal dec_WR_REV is generated, and the writing to the correction register is executed at a timing determined by this decision.

As explained above, according to the conventional method, in order to avoid the execution of a correction during an unintended count period, the operation status of the counter has been checked by software. Thus, it has been necessary to carry out the operation and processing different from the main operation. This has been an increase in the load of software, and the correction work has also been troublesome.

### SUMMARY OF THE INVENTION

It is an object of the present invention to provide a timer circuit in which it is possible to easily correct the count period.

In the timer circuit according to one aspect of the present invention, a counter sequentially carries out the count operation during a first count period and a subsequent second count period. A deciding unit detects presence or absence of the completion of the count operation during the first count period. Based on this, the deciding unit makes a decision about whether the counter is currently carrying out the count operation during the first count period or the second count period. While this deciding unit is originally used for carrying out the control within one circuit, this is used in the present invention because of the characteristics of this unit. In the meantime, a setting unit sets a correction-intended count period. This can be generated based on a control signal for discriminating between the first count period and the second count period that is used for other purpose. When a correction request has been generated, a correction value is written into the storage unit. At the same time, the count period correcting unit makes a decision about whether the count period decided by the deciding unit coincides with the count period set by the setting unit. When both count periods coincide with each other, the count period correcting unit sets the correction value written in the storage unit to the counter that is carrying out the count operation during the coincided count period, and makes the counter execute the count operation based on the set correction value.

In the timer circuit according to one aspect of the present invention, a counter sequentially carries out the count operation during a first count period and a subsequent second count period. A deciding unit detects presence or absence of the completion of the count operation during the first count period. Based on this, the deciding unit makes a decision about whether the counter is currently carrying out the count operation during the first count period or the second count period. This deciding unit is originally used for carrying out the control within one circuit. However, because of the characteristics of this unit, this is used in the present invention. A correction request for the first count period and a correction request for the second count request are generated separately as correction requests. A correction value for the first count period and a correction value for the second count period are written into the storage unit upon reception of the respective correction requests. When a correction request has been generated, a correction value for a corresponding count period is written into the storage unit. At the same time, a count period correcting unit makes a decision about whether the count period corresponding to this correction request coincides with the count period decided by the deciding unit or not. When both count periods coincide with each other, the count period correcting unit sets the correction value for the corresponding count period written in the storage unit to the counter, and makes the counter execute the count operation based on the set correction value.

Other objects and features of this invention will become apparent from the following description with reference to the accompanying drawings.

### BRIEF DESCRIPTION OF THE DRAWINGS

FIG. 1 is a block diagram showing a structure of a timer circuit according to a first embodiment of the present invention;

FIG. 2 is a circuit diagram showing a detailed structure example of a control clock generator shown in FIG. 1;

FIG. 3 is a circuit diagram showing a detailed structure example of a correction value write controller shown in FIG. 1;

FIG. 4 is a time chart for explaining a correction operation of a count period when an effective period assign signal REV_MOD and a counter status signal CNT_UDF are both at the “L” level, and a correction execution post signal dec_WR_REV and a source count clock INCLK1 overlap with each other;

FIG. 5 is a time chart for explaining a correction operation of a count period when an effective period assign signal REV_MOD and a counter status signal CNT_UDF are both at the “L” level, and a correction execution post signal dec_WR_REV and a source count clock INCLK1 do not overlap with each other;

FIG. 6 is a time chart for explaining a correction operation of a count period when an effective period assign signal REV_MOD is at the “H” level and a counter status signal CNT_UDF is at the “L” level, and a correction execution post signal dec_WR_REV and a source count clock INCLK1 overlap with each other;

FIG. 7 is a time chart for explaining a correction operation of a count period when an effective period assign signal REV_MOD is at the “H” level and a counter status signal CNT_UDF is at the “L” level, and a correction execution post signal dec_WR_REV and a source count clock INCLK1 do not overlap with each other;

FIG. 8 is a time chart for explaining a correction operation of a count period when an effective period assign signal REV_MOD is at the “L” level and a counter status signal CNT_UDF is at the “H” level, and a correction execution post signal dec_WR_REV and a source count clock INCLK1 overlap with each other;

FIG. 9 is a time chart for explaining a correction operation of a count period when an effective period assign signal REV_MOD is at the “L” level and a counter status signal CNT_UDF is at the “H” level, and a correction execution post signal dec_WR_REV and a source count clock INCLK1 do not overlap with each other;

FIG. 10 is a time chart for explaining a correction operation of a count period when both an effective period assign signal REV_MOD and a counter status signal CNT_UDF are at the “H” level, and a correction execution post signal dec_WR_REV and a source count clock INCLK1 overlap with each other;

FIG. 11 is a time chart for explaining a correction operation of a count period when both an effective period assign signal REV_MOD and a counter status signal CNT_UDF are at the “H” level, and a correction execution post signal dec_WR_REV and a source count clock INCLK1 do not overlap with each other;

FIG. 12 is a block diagram showing a structure of a timer circuit according to a second embodiment of the present invention;

FIG. 13 is a circuit diagram showing a detailed structure example of a correction value write controller shown in FIG. 12;

FIG. 14 is a time chart for explaining a correction operation of a count period when an effective period assign signal REV_MOD and a counter status signal CNT_UDF are both at the “L” level, and a correction execution post signal dec_WR_REV and a source count clock INCLK1 overlap with each other;

FIG. 15 is a time chart for explaining a correction operation of a count period when an effective period assign signal REV_MOD and a counter status signal CNT_UDF are both at the “L” level, and a correction execution post signal dec_WR_REV and a source count clock INCLK1 do not overlap with each other;

FIG. 16 is a time chart for explaining a correction operation of a count period when an effective period assign signal REV_MOD is at the “H” level and a counter status signal CNT_UDF is at the “L” level, and a correction execution post signal dec_WR_REV and a source count clock INCLK1 overlap with each other;

FIG. 17 is a time chart for explaining a correction operation of a count period when an effective period assign signal REV_MOD is at the “H” level and a counter status signal CNT_UDF is at the “L” level, and a correction execution post signal dec_WR_REV and a source count clock INCLK1 do not overlap with each other;

FIG. 18 is a time chart for explaining a correction operation of a count period when an effective period assign signal REV_MOD is at the “L” level and a counter status signal CNT_UDF is at the “H” level, and a correction execution post signal dec_WR_REV and a source count clock INCLK1 overlap with each other;

FIG. 19 is a time chart for explaining a correction operation of a count period when an effective period assign signal REV_MOD is at the “L” level and a counter status signal CNT_UDF is at the “H” level, and a correction execution post signal dec_WR_REV and a source count clock INCLK1 do not overlap with each other;

FIG. 20 is a time chart for explaining a correction operation of a count period when both an effective period assign signal REV_MOD and a counter status signal CNT_UDF are at the “H” level, and a correction execution post signal dec_WR_REV and a source count clock INCLK1 overlap with each other;

FIG. 21 is a time chart for explaining a correction operation of a count period when both an effective period assign signal REV_MOD and a counter status signal CNT_UDF are at the “H” level, and a correction execution post signal dec_WR_REV and a source count clock INCLK1 do not overlap with each other;

FIG. 22 is a block diagram showing a structure of a timer circuit according to a third embodiment of the present invention;

FIG. 23 is a circuit diagram showing a detailed structure example of a correction value write controller shown in FIG. 22;

FIG. 24 is a block diagram showing a structure of a timer circuit according to a fourth embodiment of the present invention;

FIG. 25 is a circuit diagram showing a detailed structure example of a correction value write controller shown in FIG. 24;

FIG. 26 is a block diagram showing a structure of a timer circuit according to a fifth embodiment of the present invention;

FIG. 27 is a circuit diagram showing a detailed structure example of a correction value write controller shown in FIG. 26;

FIG. 28 is a block diagram showing a structure of a timer circuit according to a sixth embodiment of the present invention;

FIG. 29 is a circuit diagram showing a detailed structure example of a correction value write controller shown in FIG. 28;

FIG. 30 is a circuit diagram showing an example of structure of a conventional timer circuit;

FIG. 31 is a diagram showing an example of structure of a clock generator;

FIG. 32 is a concept diagram showing an internal structure of an F/F 302 in FIG. 31;

FIG. 33 is a diagram showing a detailed structure example of a count period controller shown in FIG. 30;

FIG. 34 is a diagram showing a detailed structure example of a correction value write controller 123 shown in FIG. 30;

FIG. 35 is a diagram showing a detailed structure example of a counter value write controller shown in FIG. 30;

FIG. 36 is a diagram showing a detailed structure example of a reload value write controller shown in FIG. 30;

FIG. 37 is a diagram showing a detailed structure example of an output signal generator shown in FIG. 30;

FIG. 38 is a time chart for explaining a delayed one-shot operation mode;

FIG. 39 is a time chart for explaining a correction operation of a count period when a correction execution post signal dec_WR_REV is generated in overlap with a source count clock INCLK1; and

FIG. 40 is a time chart for explaining a correction operation of a count period when a correction execution post signal dec_WR_REV is generated in not overlap with a source count clock INCLK1.

### DESCRIPTION OF THE PREFERRED EMBODIMENTS

Embodiments of a timer circuit relating to the present invention will be explained in detail below with reference to the attached drawings.

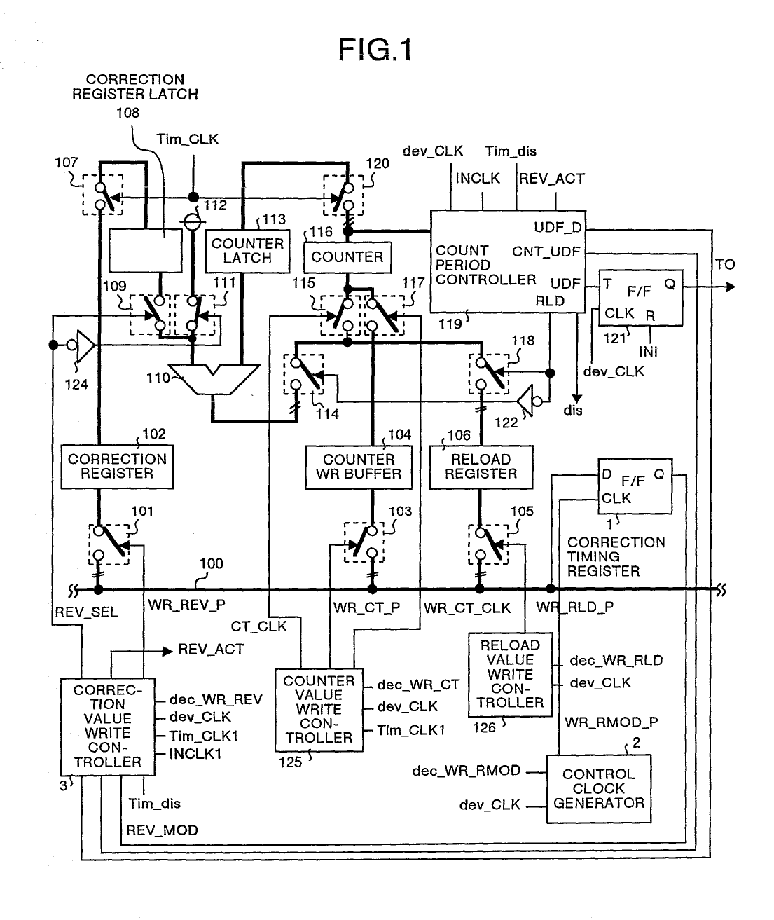

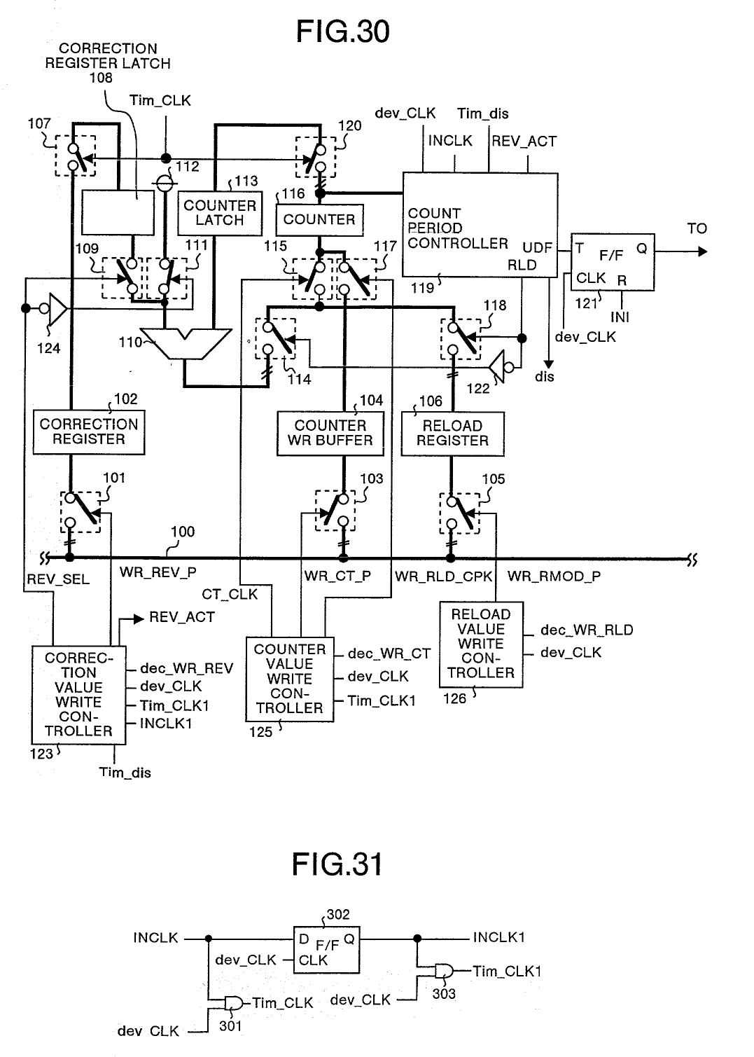

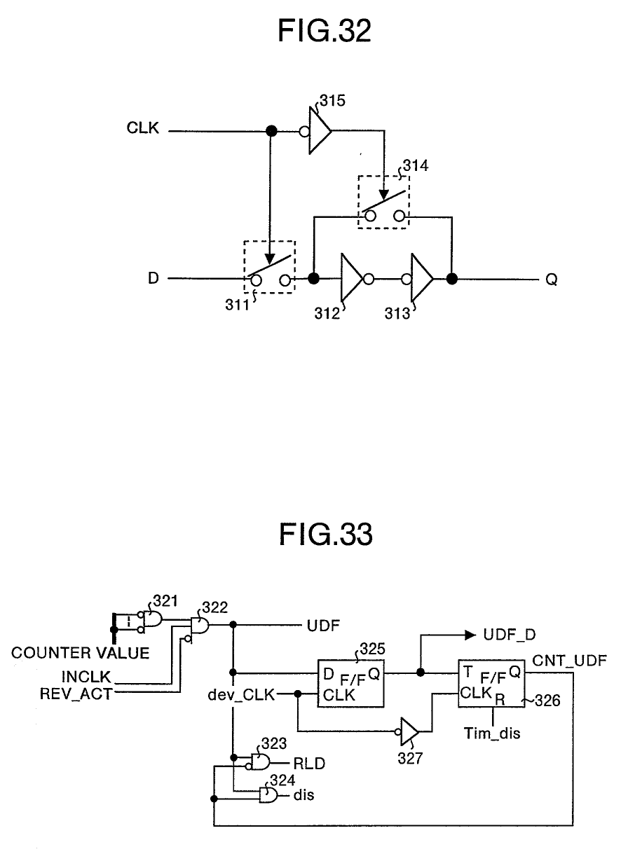

FIG. 1 is a block diagram showing a structure of a timer circuit according to a first embodiment of the present invention. In FIG. 1, elements having the same functions as those of the timer circuit shown in FIG. 30 are attached with like reference numbers. A portion relating to the first embodiment, that is, a correction function for correcting a count period will be mainly explained in the present embodiment, and this similarly applies to the other embodiments.

As shown in FIG. 1, the timer circuit of this first embodiment is newly provided with the correction timing register 1 and the control clock generator 2 consisting of a D flip-flop in the timer circuit shown in FIG. 30.

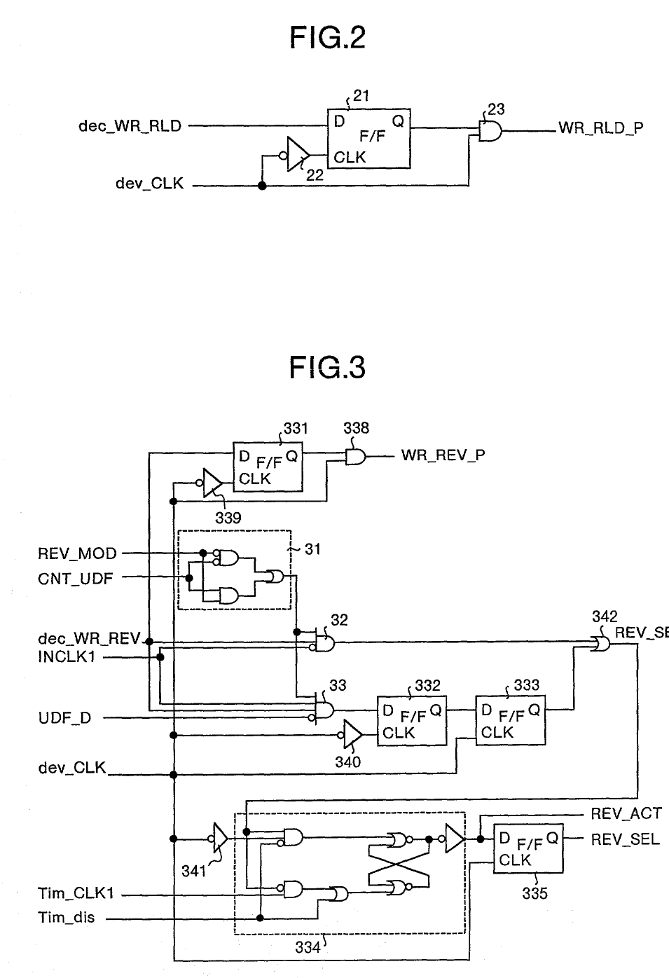

The control clock generator 2 generates a control clock WR_RMOD_P based on a control signal dec_WR_RMOD and an operation clock dec_CLK that are input from the outside, and applies the generated control clock WR_RMOD_P to a correction timing register 2. This control clock generator 2 consists of an F/F 21, an inverter 22, and an AND gate 23, as shown in FIG. 2, for example.

As shown in FIG. 2, the F/F 21 is input with a control signal dec_WR_RMOD that has been generated at the outside, at a data input terminal D. The F/F 21 is also input with an operation clock dev_CLK at a clock input terminal CLK via the inverter 22. Then, the F/F 21 outputs the control signal dec WR_RMOD from an output terminal Q to the AND gate 23 in synchronism with the “L” timing of the operation clock dev_CLK. The AND gate 23 generates an output of the F/F 21 in synchronism with the “H” timing of the operation clock dev_CLK as a control clock WR_RMOD_P. In this way, the control clock generator 2 generates the control clock WR_RMOD_P.

Referring back to FIG. 1, the correction timing register 1 is input with one control signal (for example, a control signal for discriminating between a delay period in the delayed one-shot operation mode and a subsequent one-shot period) in a data bus 100, at a data input terminal D. The correction timing register 1 is also input with a control clock WR_RMOD_P at a clock input terminal CLK, and generates an effective period assign signal REV_MOD for assigning a count period of which correction is to be made effective.

When the effective period assign signal REV_MOD is at the “L” level, the effective period assign signal REV_MOD indicates that a correction of a count period based on a set value of a counter WR buffer 104 is effective. When the effective period assign signal REV_MOD is at the “H” level, the effective period assign signal REV_MOD indicates that a correction of a count period based on a set value of a reload register 106 is effective.

As shown in FIG. 1, the timer circuit according to the first embodiment has a correction value write controller 3 in place of the correction value write controller 123 in the timer circuit shown in FIG. 30. The correction value write controller 3 uses the control signal UDF_D and the counter status signal CNT_UDF that have conventionally been used inside the count period controller 119. The correction value write controller 3 is input with the effective period assign signal REV_MOD from the correction timing register 1.

In this case, a status that the counter status signal CNT_UDF is at the “L” level means that the timer circuit is in the disable status or in the status during a period from when the timer has started till when a first underflow occurs (that is, in a down-count operation status based on a set value of the counter WR buffer 104). Further, a status that the counter status signal CNT_UDF is at the “H” level means that the timer circuit is in the status during a period from when the first underflow is generated till when a second underflow occurs, that is, in a down-count operation status based on a set value of the reload register 106. In the present invention, this characteristic is positively utilized.

The correction value write controller 3 executes a writing to a correction register 102 upon reception of a correction execution post signal dec_WR_REV, in a similar manner to that of the correction value write controller 123. According to the first embodiment, the correction operation is controlled as follows.

Namely, in executing-the writing to the correction register 102 after receiving the correction execution post signal dec WR_REV, the correction value write controller 3 makes a decision about a count period of which correction is effective, based on the effective period assign signal REV_MOD and the counter status signal CNT_UDF. Then, the correction value write controller 3 executes the correction operation by making effective the correction execution post signal dec_WR_REV that has been generated during the decided correction effective count period. In other cases, the correction value write controller 3 does not execute the correction processing by making the correction execution post signal dec_WR_REV ineffective.

The correction value write controller 3 has a structure as shown in FIG. 3, for example. FIG. 3 shows portions relating to the first embodiment in addition to the structure shown in FIG. 35. In other words, FIG. 3 has an addition of a detecting circuit 31 that consists of an AND gate and an OR gate, an AND gate 32 that replaces the AND gate 336, and an AND gate 33 that replaces the AND gate 337.

The detecting circuit 31 detects a case where the effective period assign signal REV_MOD and the counter status signal CNT_UDF become the same signal status. A detection signal is input to the AND gates 32 and 33, together with a correction execution post signal dec_WR_REV and a source count clock INCLK1. An output of the AND gate 32 becomes one input to an OR gate 342. The control signal UDF_D is input to the AND gate 33. An output of the AND gate 33 is applied to a data input terminal D of an F/F 332. The rest of the structure is similar to that shown in FIG. 35.

Therefore, according to the structure shown in FIG. 3, when the correction execution post signal dec_WR_REV has been input, a write signal WR_REV_P is generated and the writing to the correction register 102 is executed in a similar manner to that of the conventional practice. However, the control signal REV_SET is generated only when the effective period assign signal REV_MOD and the counter status signal CNT_UDF are in the same signal status, and when the correction execution post signal dec_WR_REV and the source count clock INCLK1 do not overlap with each other, or when the correction execution post signal dec_WR_REV and the source count clock INCLK1 overlap with each other but a control signal UDF_D is not generated.

In this case, a select signal REV_SEL for controlling an input to an adder circuit 110 is generated, a set value of a correction register latch 108 is input to the adder circuit 110, and a counter value of a counter 116 is corrected. When the effective period assign signal REV_MOD and the counter status signal CNT_UDF are not in the same signal status, the writing to the correction register 102 is executed based on the generation of the correction execution post signal dec_WR_REV. However, the select signal REV_SEL is not generated, and the counter value of the counter 116 is not corrected.

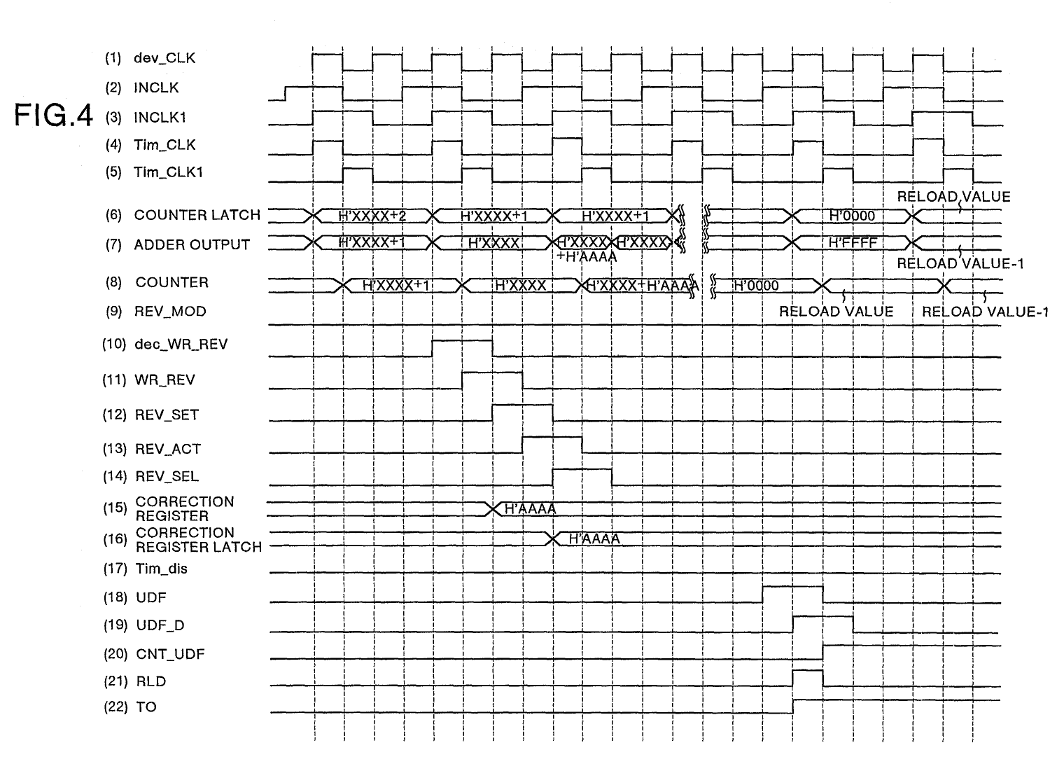

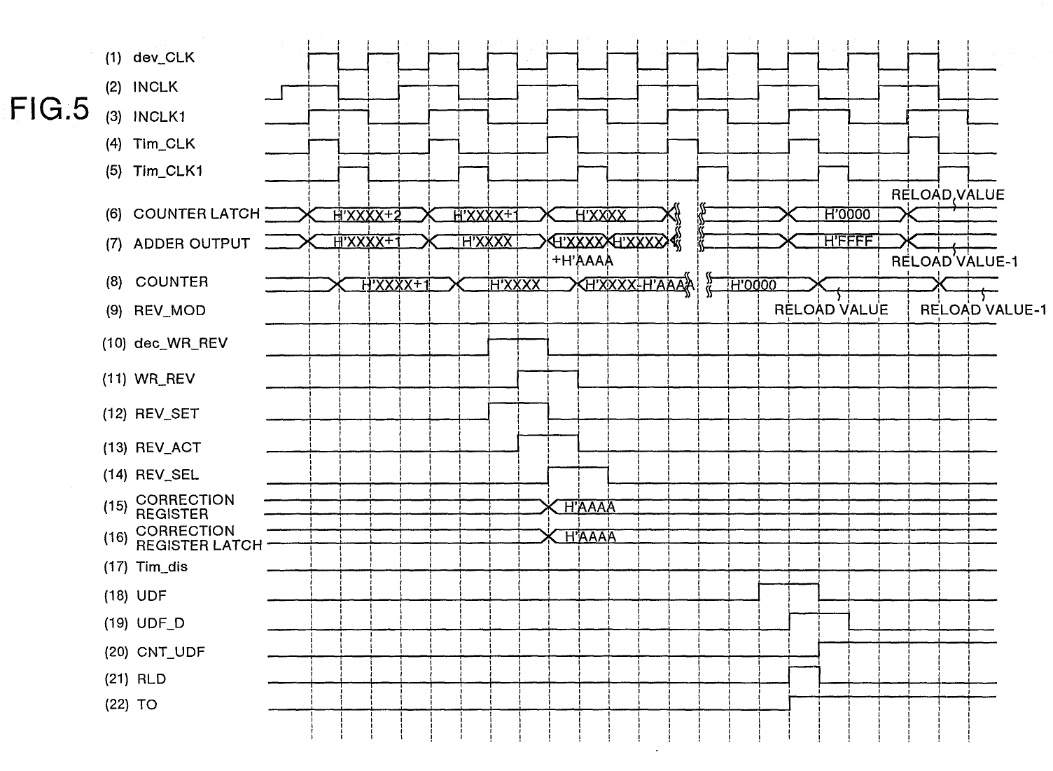

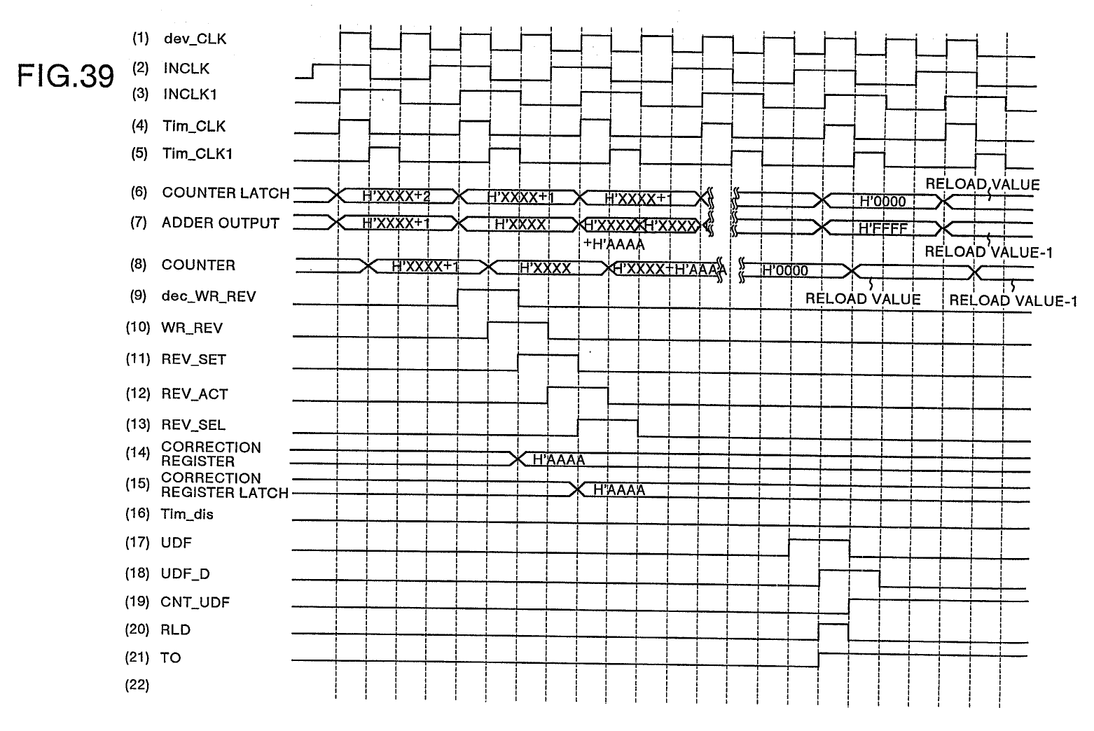

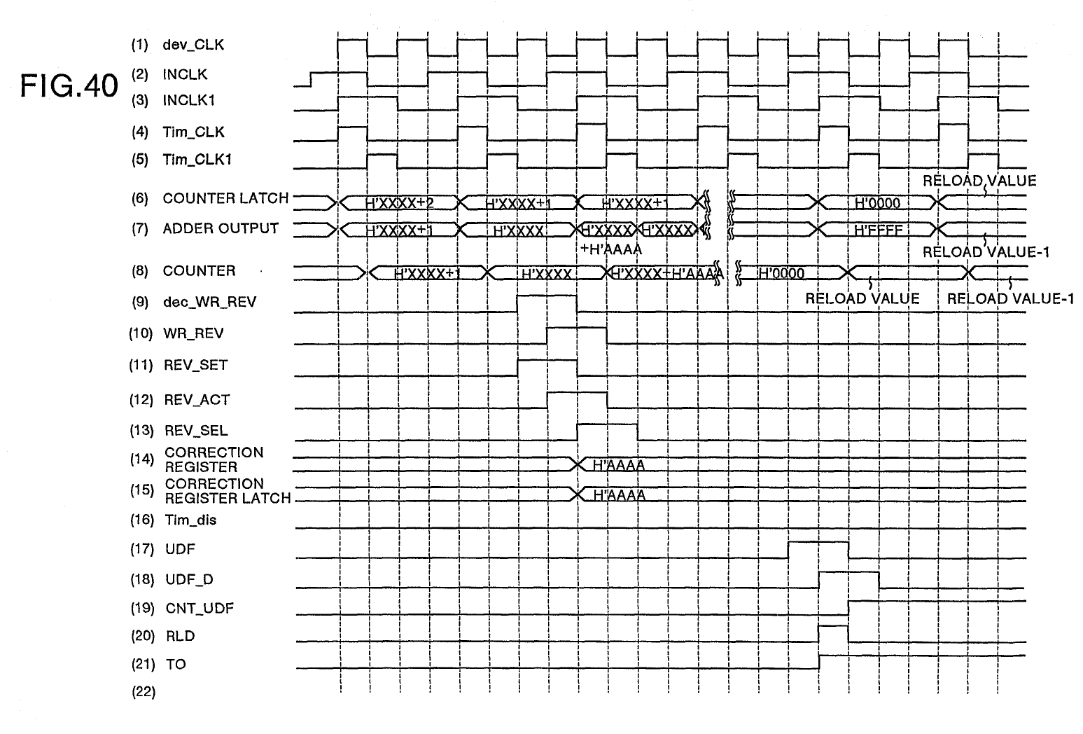

The correction operation of a count period of the timer circuit having the above-described structure will be explained below with reference to time charts shown in FIG. 4 to FIG. 11. FIG. 4 to FIG. 11 show the effective period assign signal REV_MOD in addition to the time charts shown in FIG. 39 and FIG. 40.

FIG. 4 is a time chart for explaining a correction operation of a count period when an effective period assign signal REV_MOD and a counter status signal CNT_UDF are both at the “L” level, and a correction execution post signal dec_WR_REV and a source count clock INCLK1 overlap with each other. FIG. 5 is a time chart for explaining a correction operation of a count period when an effective period assign signal REV_MOD and a counter status signal CNT_UDF are both at the “L” level, and a correction execution post signal dec_WR_REV and a source count clock INCLK1 do not overlap with each other.

FIG. 4 and FIG. 5 show that the correction of a count period based on the set value of the counter WR buffer 104 is effective, as the effective period assign signal REV_MOD (9) is at the “L” level at the generation timing of the correction execution post signal dec_WR_REV (10). Further, FIG. 4 and FIG. 5 show that the counter 116 is in the counter operation status based on the set value of the counter WR buffer 104, as the counter status signal CNT_UDF is at the “L” level at the generation timing of the correction execution post signal dec_WR_REV (10).

The count period indicated by the effective period assign signal REV_MOD coincides with the counter operation status shown by the counter status signal CNT_UDF. Therefore, in the case of FIG. 4, after the generation of the correction execution post signal dec_WR_REV (10), a control signal WR_REV (11) is generated, and the writing to the correction register 102 is executed (15). Then, a control signal REV_SET (12), a correction execute signal REV_ACT (13), and a select signal REV_SEL (14) are generated sequentially, and a setting to the correction register latch 108 is carried out (16). This set value is input to the adder circuit 110. As a result, the correction of the count period is executed based on the set value of the counter WR buffer 104.

In the case of FIG. 5, after the generation of the correction execution post signal dec_WR_REV (10), a control signal WR_REV (11) is generated, and the writing to the correction register 102 is executed (15). Then, based on the control signal REV_SET (12) that is generated at the same timing as the generation of the correction execution post signal dec_WR_REV (10), the correction execute signal REV_ACT (13) and the select signal REV_SEL (14) are generated sequentially, and the setting to the correction register latch 108 is carried out (16). This set value is input to the adder circuit 110. As a result, the correction of the count period is executed based on the set value of the counter WR buffer 104.

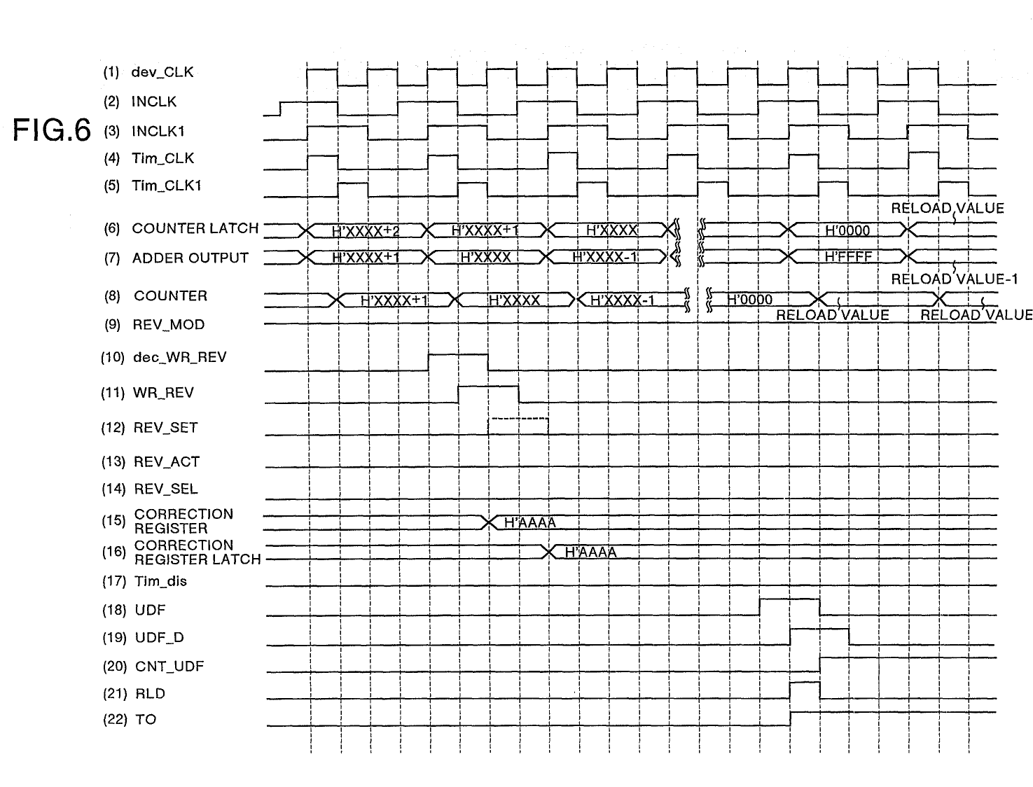

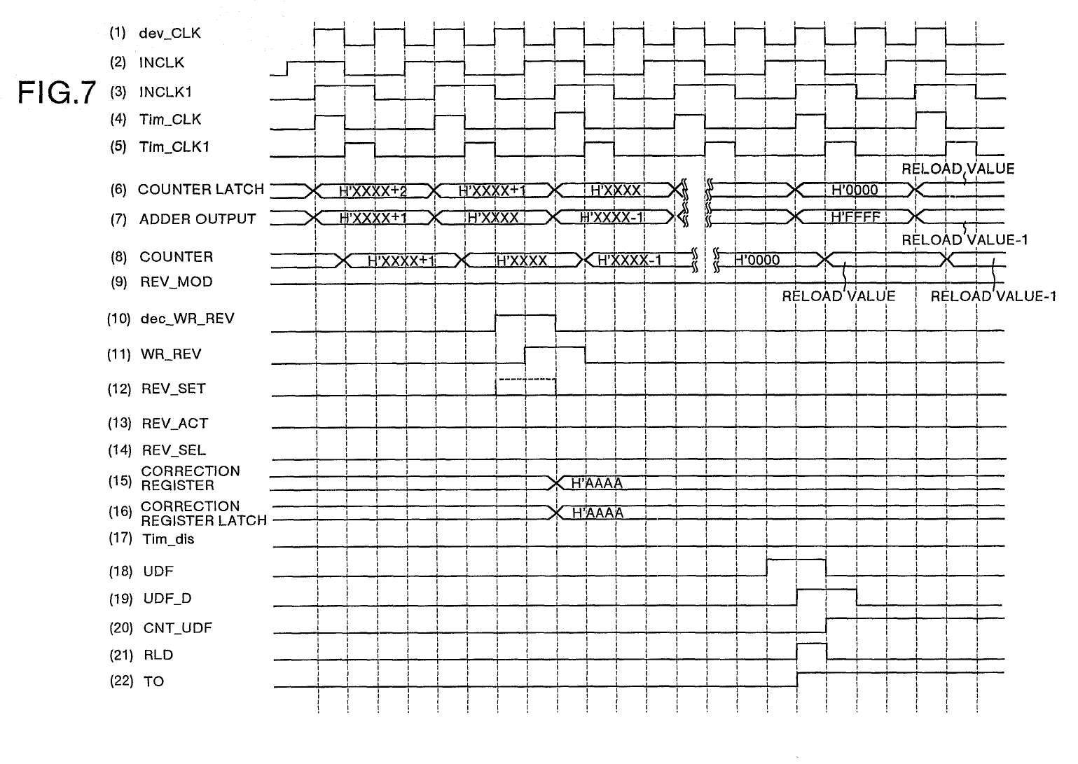

FIG. 6 is a time chart for explaining a correction operation of a count period when an effective period assign signal REV_MOD is at the “H” level and a counter status signal CNT_UDF is at the “L” level, and a correction execution post signal dec_WR_REV and a source count clock INCLK1 overlap with each other. FIG. 7 is a time chart for explaining a correction operation of a count period when an effective period assign signal REV_MOD is at the “H” level and a counter status signal CNT_UDF is at the “L” level, and a correction execution post signal dec_WR_REV and a source count clock INCLK1 do not overlap with each other.

FIG. 6 and FIG. 7 show that the correction of a count period based on the set value of the reload register 106 is effective, as the effective period assign signal REV_MOD (9) is at the “H” level at the generation timing of the correction execution post signal dec_WR_REV (10). Further, FIG. 6 and FIG. 7 show that the counter 116 is in the counter operation status based on the set value of the counter WR buffer 104, as the counter status signal CNT_UDF is at the “L” level at the generation timing of the correction execution post signal dec_WR_REV (10).

The count period indicated by the effective period assign signal REV_MOD does not coincide with the counter operation status shown by the counter status signal CNT_UDF. Therefore, in the case of FIG. 6 and FIG. 7, after the generation of the correction execution post signal dec_WR_REV (10), the control signal WR_REV (11) is generated, and the writing to the correction register 102 is executed (15). However, the control signal REV_SET (12) is not generated. As a result, the correction of the count period is not executed.

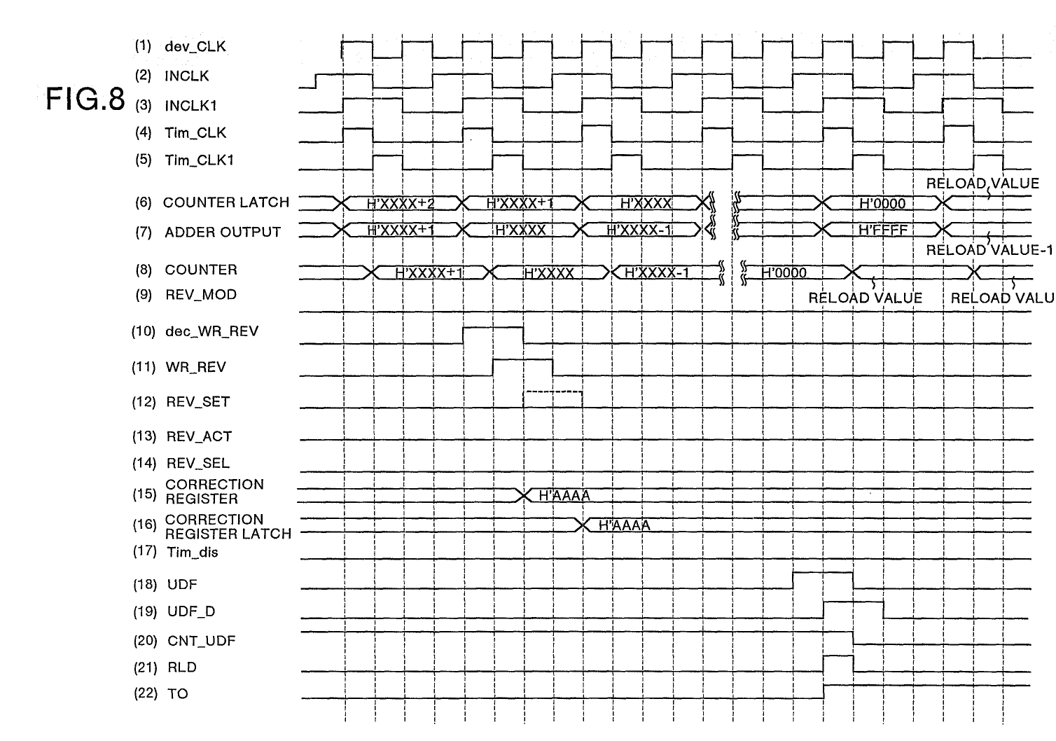

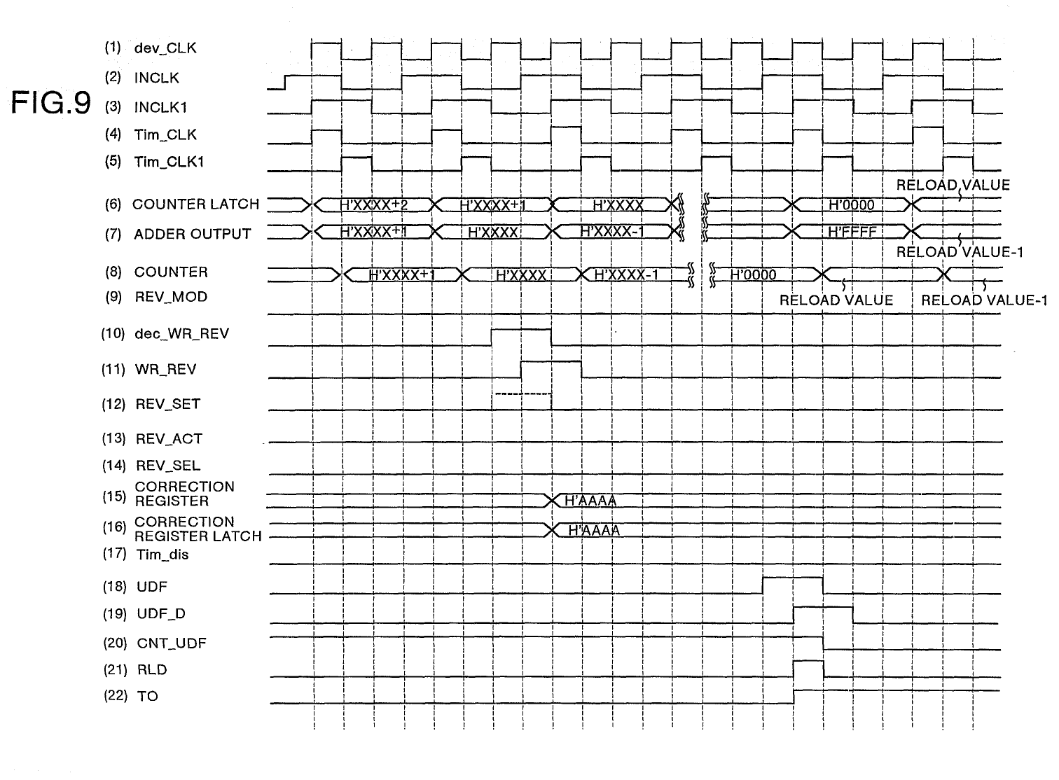

FIG. 8 is a time chart for explaining a correction operation of a count period when an effective period assign signal REV_MOD is at the “L” level and a counter status signal CNT_UDF is at the “H” level, and a correction execution post signal dec_WR_REV and a source count clock INCLK1 overlap with each other. FIG. 9 is a time chart for explaining a correction operation of a count period when an effective period assign signal REV_MOD is at the “L” level and a counter status signal CNT_UDF is at the “H” level, and a correction execution post signal dec_WR_REV and a source count clock INCLK1 do not overlap with each other.

FIG. 8 and FIG. 9 show that the correction of a count period based on the set value of the counter WR buffer 104 is effective, as the effective period assign signal REV_MOD (9) is at the “L” level at the generation timing of the correction execution post signal dec_WR_REV (10). Further, FIG. 8 and FIG. 9 show that the counter 116 is in the counter operation status based on the set value of the reload register 106, as the counter status signal CNT_UDF is at the “H” level at the generation timing of the correction execution post signal dec_WR_REV (10).

The count period indicated by the effective period assign signal REV_MOD does not coincide with the counter operation status shown by the counter status signal CNT_UDF. Therefore, in the case of FIG. 8 and FIG. 9, after the generation of the correction execution post signal dec_WR_REV (10), the control signal WR_REV (11) is generated, and the writing to the correction register 102 is executed (15). However, the control signal REV_SET (12) is not generated. As a result, the correction of the count period is not executed.

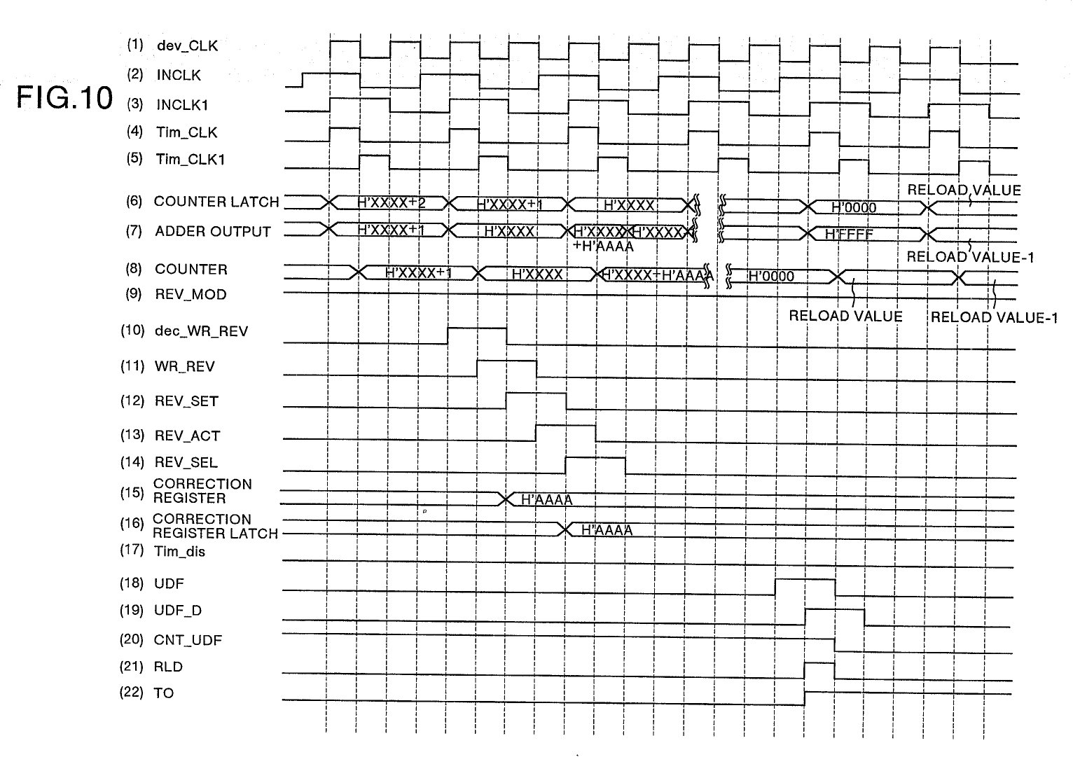

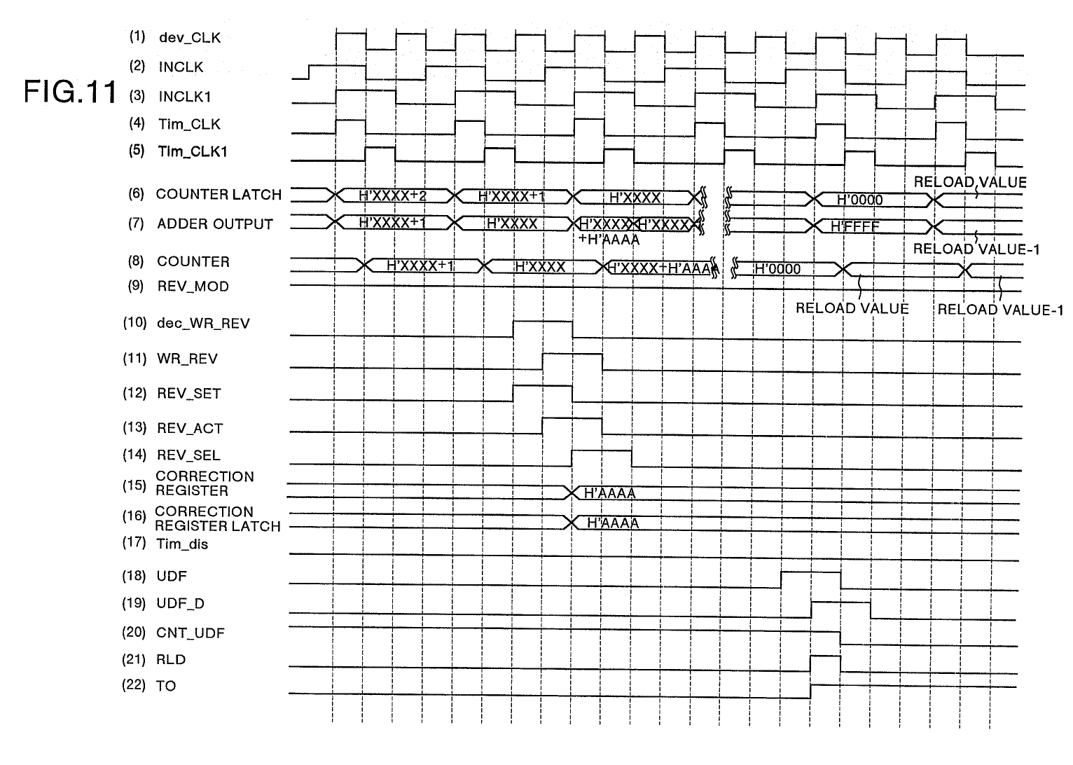

FIG. 10 is a time chart for explaining a correction operation of a count period when both an effective period assign signal REV_MOD and a counter status signal CNT_UDF are at the “H” level, and a correction execution post signal dec_WR_REV and a source count clock INCLK1 overlap with each other. FIG. 11 is a time chart for explaining a correction operation of a count period when both an effective period assign signal REV_MOD and a counter status signal CNT_UDF are at the “H” level, and a correction execution post signal dec_WR_REV and a source count clock INCLK1 do not overlap with each other.

FIG. 10 and FIG. 11 show that the correction of a count period based on the set value of the reload register 106 is effective, as the effective period assign signal REV_MOD (9) is at the “H” level at the generation timing of the correction execution post signal dec_WR_REV (10). Further, FIG. 10 and FIG. 11 show that the counter 116 is in the counter operation status based on the set value of the reload register 106, as the counter status signal CNT_UDF is at the “H” level at the generation timing of the correction execution post signal dec_WR_REV (10).

The count period indicated by the effective period assign signal REV_MOD coincides with the counter operation status shown by the counter status signal CNT_UDF. Therefore, in the case of FIG. 10, after the generation of the correction execution post signal dec_WR_REV (10), the control signal WR_REV (11) is generated, and the writing to the correction register 102 is executed (15). Then, the control signal REV_SET (12), the correction execute signal REV_ACT (13), and the select signal REV_SEL (14) are generated sequentially, and a setting to the correction register latch 108 is carried out (16). This set value is input to the adder circuit 110. As a result, the correction of the count period is executed based on the set value of the reload register 106.

In the case of FIG. 11, after the generation of the correction execution post signal dec_WR_REV (10), the control signal WR_REV (11) is generated, and the writing to the correction register 102 is executed (15). Based on the control signal REV_SET (12) that is generated at the same timing as the generation of the correction execution post signal dec_WR_REV (10), the correction execute signal REV_ACT (13) and the select signal REV_SEL (14) are generated sequentially, and the setting to the correction register latch 108 is carried out (16). This set value is input to the adder circuit 110. As a result, the correction of the count period is executed based on the set value of the reload register 106.

As explained above, according to the first embodiment, it is possible to execute easily and securely the correction of an intended count period, based on the effective period assign signal REV_MOD and the counter status signal CNT_UDF. Therefore, it is not necessary to carry out additional operation or processing like the checking of a counter operation status by software. As a result, it is possible to reduce the load of software. The counter status signal CNT_UDF is a signal that exists as a control signal within one circuit. Further, the effective period assign signal REV_MOD can be generated from a control signal for discriminating the count period that has been used for other application in the timer circuit. Therefore, it is possible to minimize an increase in hardware and software.

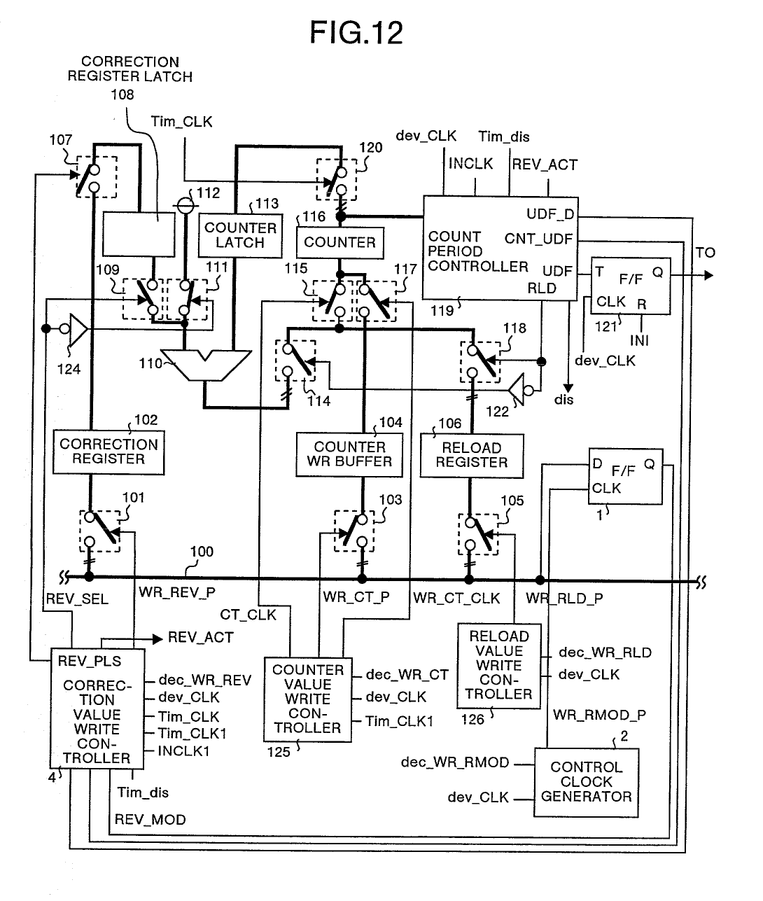

FIG. 12 is a block diagram showing a structure of a timer circuit according to a second embodiment of the present invention. As shown in FIG. 12, the timer circuit according the second embodiment has a correction control signal generator 4 in place of the correction value write controller 3, in the first embodiment (FIG. 1). The correction control signal generator 4 generates a read signal REV_PLS to ON/OFF control a SW 107 that controls the setting to a correction register latch 108. With this arrangement, a method of generating a select signal REV_SEL is different from that of a correction execute signal REV_ACT. The rest of the structure is similar to that of the first embodiment (FIG. 1).

According to the second embodiment, when a count period indicated by the effective period assign signal REV_MOD coincides with a count operation status shown by the counter status signal CNT_UDF, the correction is executed immediately in a similar manner to that of the first embodiment. Further, when a count period indicated by the effective period assign signal REV_MOD does not coincide with a count operation status shown by the counter status signal CNT_UDF, and when the effective period assign signal REV_MOD is at the “H” level and the counter status signal CNT_UDF is at the “L” level, the correction of the count period is executed after waiting until the counter status signal CNT_UDF has become at the “H” level. The correction is ineffective while the timer operation is stopped, like in the first embodiment.

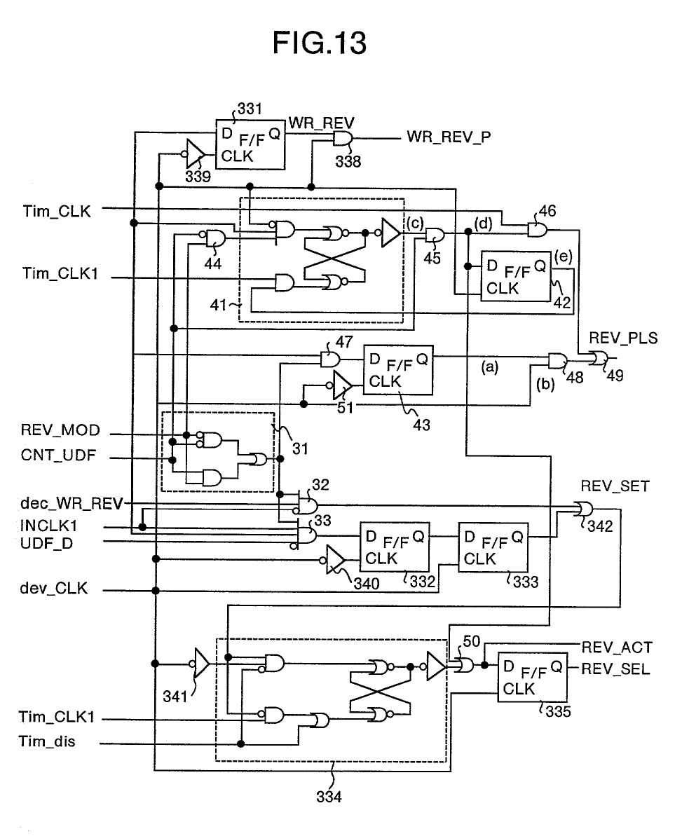

The correction control signal generator 4 has a structure as shown in FIG. 13, for example. FIG. 13 shows portions relating to the second embodiment in addition to the structure shown in FIG. 3. In other words, FIG. 13 has an addition of F/Fs 41, 42 and 43, AND gates 44, 45, 46, 47 and 48, OR gates 49 and 50, and an inverter 51.

The AND gate 44 is input with an effective period assign signal REV_MOD and a counter status signal CNT_UDF. The F/F 41 is input with an operation clock dev_CLK, a correction execution post signal dec_WR_REV, and an output signal of the AND gate 44, as set signals. The AND gate 45 is input with an output (c) of the F/F 41, and a counter status signal CNT_UDF. The AND gate 46 is input with a timer clock Tim_CLK and an output (d) of the AND gate 45. The F/F 42 is input with the output (d) of the AND gate 45 at a data input terminal D, and is input with an operation clock dev_CLK at a clock input terminal CLK. The F/F 41 is input with a timer clock Tim_CLK1 and an output (e) of the F/F 42 as rest signals.

The AND gate 47 is input with a correction execution post signal dec_WR_REV and an output of a detecting circuit 31. The F/F 43 is input with an output of the AND gate 47 at a data input terminal D, and is also input with an operation clock dev_CLK at a clock input terminal CLK via an inverter 51. The AND gate 48 is input with an output (a) of the F/F 43 and an operation clock dev_CLK. The OR gate 49 is input with an output (f) of the AND gate 46 and an output (b) of the AND gate 48. With this arrangement, a control signal REV_PLS is output from the OR gate 49, and a SW 107 is ON/OFF controlled. An output of an F/F 334 and the output (d) of the AND gate 45 are input to a data input terminal D of an F/F 335 via the OR gate 50.

In the above structure, when a correction execution post signal dec_WR_REV has been generated, a write signal WR_REV_P is output from the AND gate 338, and the writing to a correction register 102 is executed, in a similar manner to that of the first embodiment. When a count period indicated by the effective period assign signal REV_MOD coincides with a counter operation status shown by the counter status signal CNT_UDF at a generation timing of the correction execution post signal dec_WR_REV, REV_SET is output from the OR gate 342, REV_ACT is output from the F/F 334, and a select signal REV_SEL is output from the F/F 335, based on a coincidence detection signal from the detecting circuit 31, in a similar manner to that of the first embodiment.

In this case, a coincidence detection signal from the detecting circuit 31 is read into the F/F 43 via the AND gate 47 in synchronism with the “L” timing of the operation clock dev_CLK. The F/F 43 then generates the output (a) at the “H” level. This output (a) is input to the OR gate 49 as the output (b) from the AND gate 48 in synchronism with the “H” timing of the subsequent operation clock dev_CLK. Then, the read signal REV_PLS is output from the OR gate 49. Thus, the SW 107 carries out the ON operation, and the set value of the correction register 102 is read into the correction register latch 108, and is input to the adder circuit 110. As a result, the correction of the count period is executed in a similar manner to that of the first embodiment.

In the second embodiment, when a count period indicated by the effective period assign signal REV_MOD does not coincide with a counter operation status shown by the counter status signal CNT_UDF at a generation timing of the correction execution post signal dec_WR_REV, the following operation is carried out when the effective period assign signal REV_MOD has become at the “H” level and the counter status signal CNT_UDF has become at the “L” level.

Namely, when the AND gate 44 has detected that the effective period assign signal REV_MOD is at the “H” level and the counter status signal CNT_UDF is at the “L” level, the F/F 41 is set, and the output (c) at the “H” level is applied to the AND gate 45. Then, this “H” level is held. In synchronism with a subsequent timing that the counter status signal CNT_UDF changes from the “L” level to the “H” level, the AND gate 45 generates the output (d) . The output (d) of the AND gate 45 is applied to the OR gate 49 from the AND gate 46 in synchronism with the timer clock Tim_CLK. The OR gate 49 then outputs the read signal REV_PLS. As a result, the SW 107 carries out the ON operation, and the set value of the correction register 102 is read into the correction register latch 108.

The output (d) of the AND gate 45 is generated as the correction execute signal REV_ACT via the OR gate 50. At the same time, the output (d) of the AND gate 45 is read into the F/F 335 in synchronism with the operation clock dev_CLK, and is output as the select signal REV_SEL from the F/F 335. Thus, the set value of the correction register latch 108 is input to the adder circuit 110, and the count period is corrected. As explained above, in executing the correction, the writing to the correction register 102 and the setting to the correction register latch 108 are carried out at the same time. The output (d) of the AND gate 45 is read into the F/F 42 in synchronism with the operation clock dev_CLK, and the F/F 41 is reset based on the output (e) of the F/F 42.

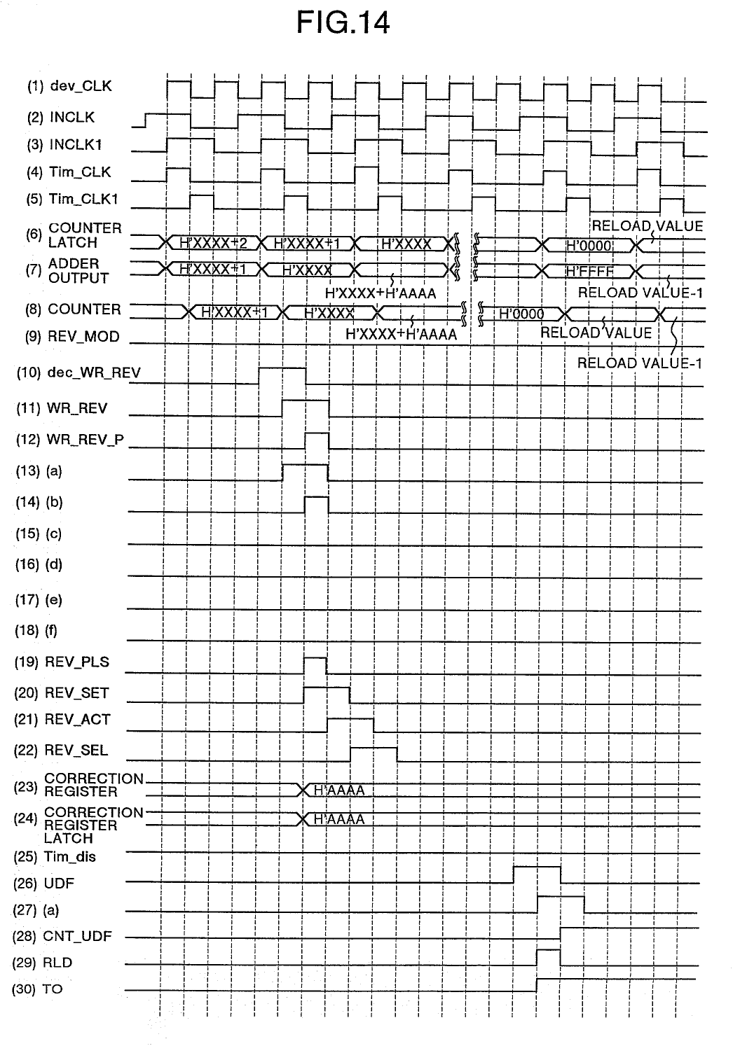

The correction operation of a count period of the timer circuit having the above-described structure will be explained below with reference to time charts shown in FIG. 14 to FIG. 21. FIG. 14 to FIG. 21 show the output (a) of the F/F 43, the output (b) of the AND gate 48, the output (c) of the F/F 41, the output (d) of the AND gate 45, the output (e) of the F/F 42, and the output (f) of the AND gate 46, in addition to (13) to (18) in FIG. 13.

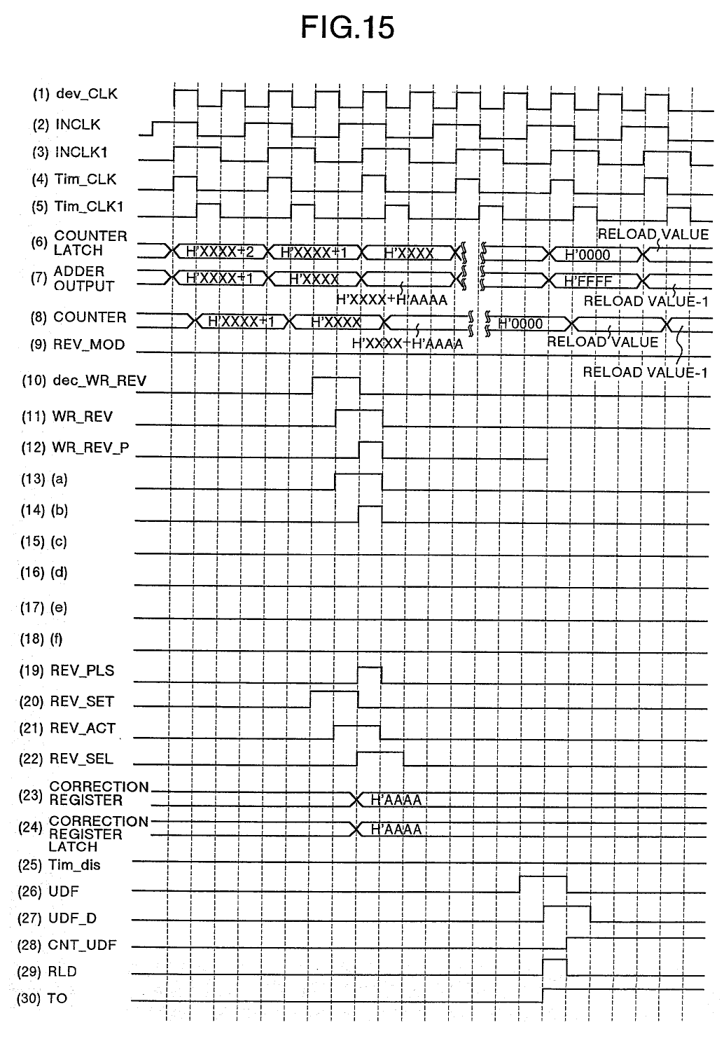

FIG. 14 is a time chart for explaining a correction operation of a count period when an effective period assign signal REV_MOD and a counter status signal CNT_UDF are both at the “L” level, and a correction execution post signal dec_WR_REV and a source count clock INCLK1 overlap with each other. FIG. 15 is a time chart for explaining a correction operation of a count period when an effective period assign signal REV_MOD and a counter status signal CNT_UDF are both at the “L” level, and a correction execution post signal dec_WR_REV and a source count clock INCLK1 do not overlap with each other.

FIG. 14 and FIG. 15 show that the correction of a count period based on the set value of the counter WR buffer 104 is effective, as the effective period assign signal REV_MOD (9) is at the “L” level at the generation timing of the correction execution post signal dec_WR_REV (10). Further, FIG. 14 and FIG. 15 show that the counter 116 is in the counter operation status based on the set value of the counter WR buffer 104, as a counter status signal CNT_UDF (28) is at the “L” level at the generation timing of the correction execution post signal dec_WR_REV (10).

The count period indicated by the effective period assign signal REV_MOD coincides with the counter operation status shown by the counter status signal CNT_UDF. Therefore, after the generation of the correction execution post signal dec_WR_REV (10), a control signal WR_REV (11) and a write signal WR_REV_P (12) are generated, and the writing to the correction register 102 is executed (23). Then, after the generation of the correction execution post signal dec_WR_REV (10), the output (a) of the F/F 43 is generated (13), and the output (b) of the AND gate 48 is generated (14) in sequence.

In the case shown in FIG. 14, a read signal REV_PLS (19) and a control signal REV_SET (20) are generated at the same time, and first, a setting (24) to the correction register latch 108 is carried out. Thereafter, a correction execute signal REV_ACT (21) and a select signal REV_SEL (22) are generated sequentially. As a result, the correction of the count period is executed based on the set value of the counter WR buffer 104.

In the case shown in FIG. 15, the control signal REV_SET (20) is generated in simultaneous with the generation of the correction execution post signal dec_WR_REV (10). Thereafter, the correction execute signal REV_ACT (21) and the select signal REV_SEL (22) are generated sequentially. The read signal REV_PLS (19) is generated at a timing when the correction execute signal REV_ACT (21) and the select signal REV_SEL (22) overlap with each other. Based on this, the setting (24) to the correction register latch 108 and the inputting of this set value to the adder circuit 110 are executed at the same time. As a result, the correction of the count period is executed based on the set value of the counter WR buffer 104.

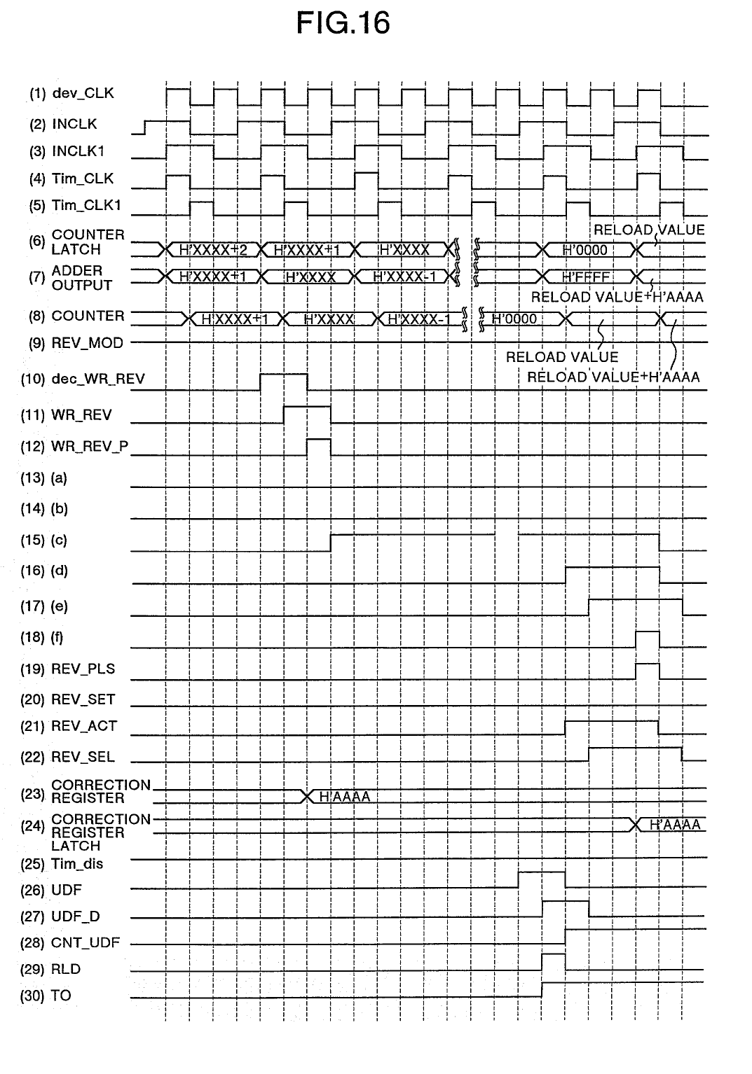

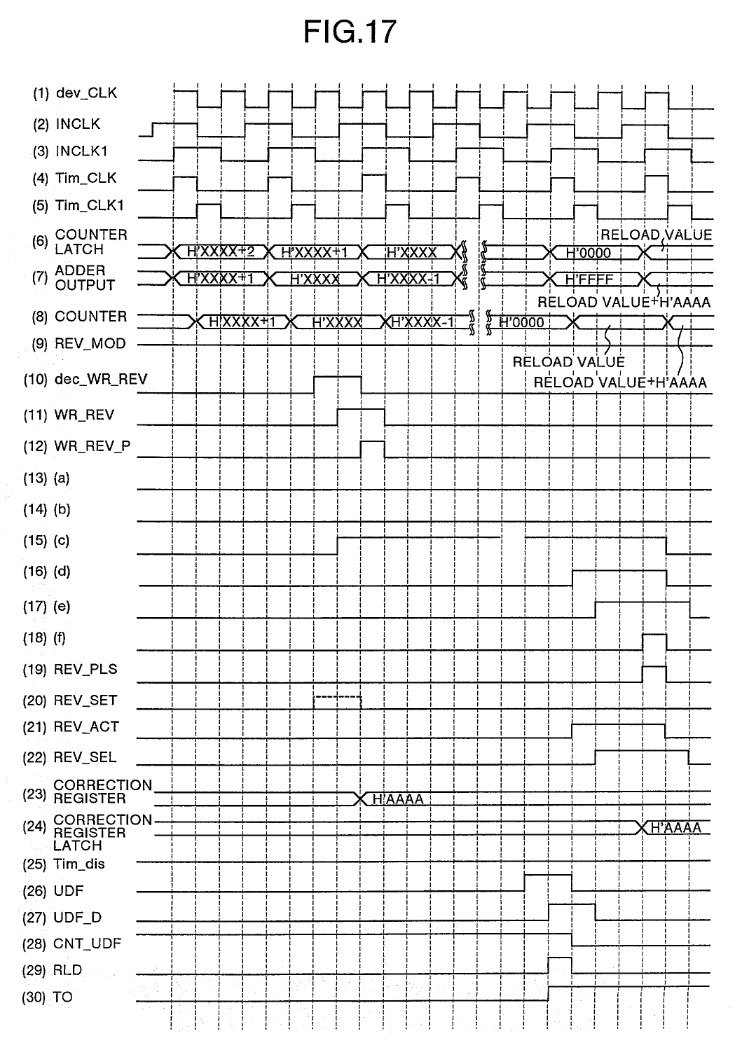

FIG. 16 is a time chart for explaining a correction operation of a count period when an effective period assign signal REV_MOD is at the “H” level and a counter status signal CNT_UDF is at the “L” level, and a correction execution post signal dec_WR_REV and a source count clock INCLK1 overlap with each other. FIG. 17 is a time chart for explaining a correction operation of a count period when an effective period assign signal REV_MOD is at the “H” level and a counter status signal CNT_UDF is at the “L” level, and a correction execution post signal dec_WR_REV and a source count clock INCLK1 do not overlap with each other.

FIG. 16 and FIG. 17 show that the correction of a count period based on the set value of the reload register 106 is effective, as the effective period assign signal REV_MOD (9) is at the “H” level at the generation timing of the correction execution post signal dec_WR_REV (10). Further, FIG. 16 and FIG. 17 show that the counter 116 is in the counter operation status based on the set value of the counter WR buffer 104, as the counter status signal CNT_UDF (28) is at the “L” level at the generation timing of the correction execution post signal dec_WR_REV (10).

The count period indicated by the effective period assign signal REV_MOD does not coincide with the counter operation status shown by the counter status signal CNT_UDF. Therefore, after the generation of the correction execution post signal dec_WR_REV (10), the control signal WR_REV (11) and the write signal WR_REV_P (12) are generated, and the writing to the correction register 102 is executed (23). However, the control signal REV_SET (20) is not generated, and the correction is not executed. In this case, the F/F 41 is set based on the generation of the correction execution post signal dec_WR_REV (10), and the output (c) is generated and maintained (15).

Therefore, when the counter status signal CNT_UDF (28) has become at the “H” level based on the generation of an underflow signal UDF (26) and a control signal UDF_D (27), the output (d) of the AND gate 45 is generated, and the correction execute signal REV_ACT (21) is generated at the same time. Based on the generation of the correction execute signal REV_ACT (21), the select signal REV_SEL (22) is generated. When the output (d) of the AND gate 45 has been generated (16), the output (f) of the AND gate 46 is generated, and the read signal REV_PLS (19) is generated.

As a result, the setting (24) to the correction register latch 108 and making output to the adder circuit 110 are carried out simultaneously, and the correction of the count period is executed based on the set value of the reload register 106. At the same time as the output (d) from the AND gate 45, the output (e) of the F/F 42 is generated (17) and the F/F 41 is reset.

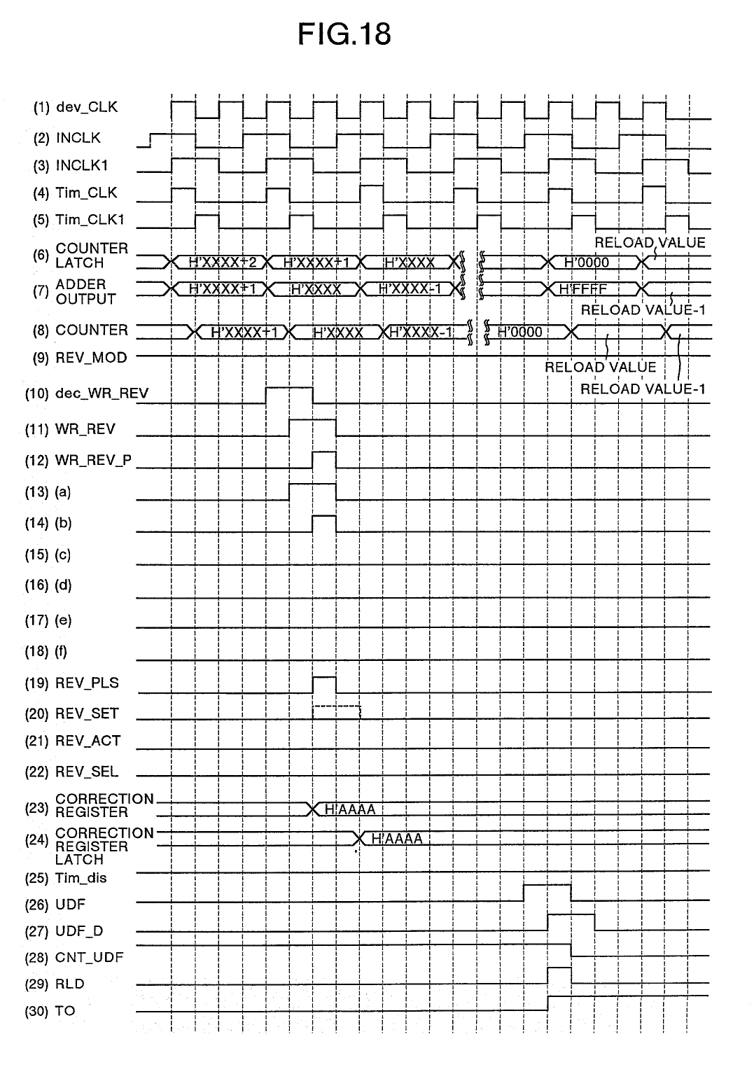

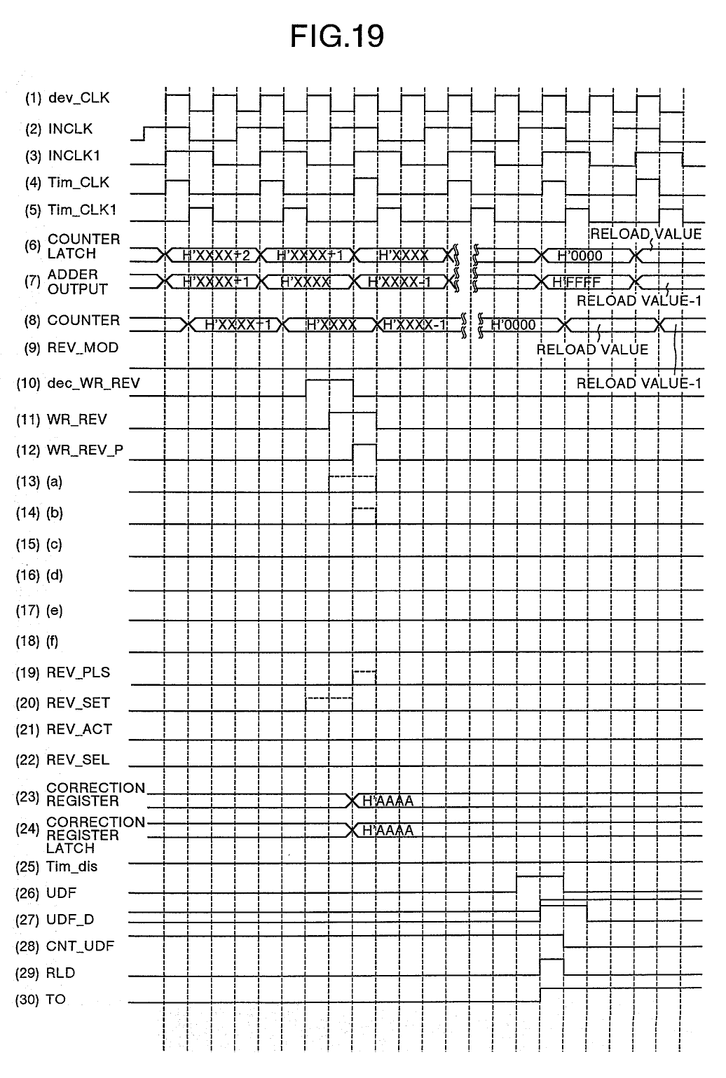

FIG. 18 is a time chart for explaining a correction operation of a count period when an effective period assign signal REV_MOD is at the “L” level and a counter status signal CNT_UDF is at the “H” level, and a correction execution post signal dec_WR_REV and a source count clock INCLK1 overlap with each other. FIG. 19 is a time chart for explaining a correction operation of a count period when an effective period assign signal REV_MOD is at the “L” level and a counter status signal CNT_UDF is at the “H” level, and a correction execution post signal dec_WR_REV and a source count clock INCLK1 do not overlap with each other.

FIG. 18 and FIG. 19 show that the correction of a count period based on the set value of the counter WR buffer 104 is effective, as the effective period assign signal REV_MOD (9) is at the “L” level at the generation timing of the correction execution post signal dec_WR_REV (10). Further, FIG. 18 and FIG. 19 show that the counter 116 is in the counter operation status based on the set value of the reload register 106, as a counter status signal CNT_UDF (28) is at the “H” level at the generation timing of the correction execution post signal dec_WR_REV (10).

The count period indicated by the effective period assign signal REV_MOD does not coincide with the counter operation status shown by the counter status signal CNT_UDF. Therefore, in the case shown in FIG. 18 and FIG. 19, after the generation of the correction execution post signal dec_WR_REV (10), the control signal WR_REV (11) and the write signal WR_REV_P (12) are generated, and the writing to the correction register 102 is executed (23). However, the control signal REV_SET (20) is not generated, and the correction of the count period is not executed.

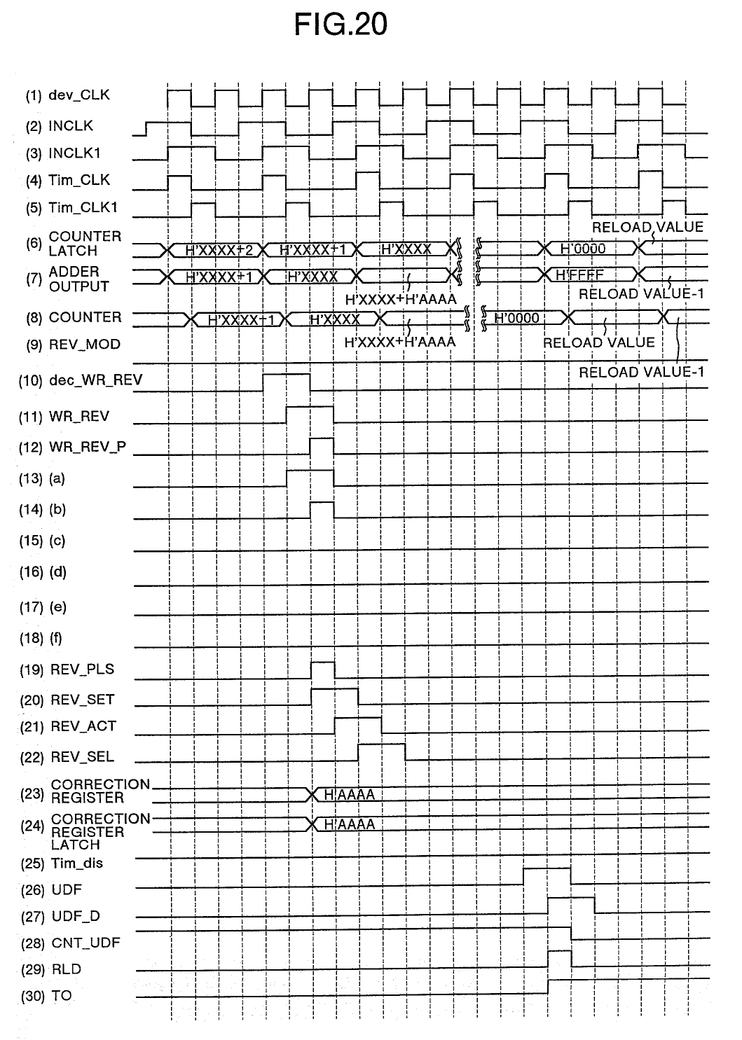

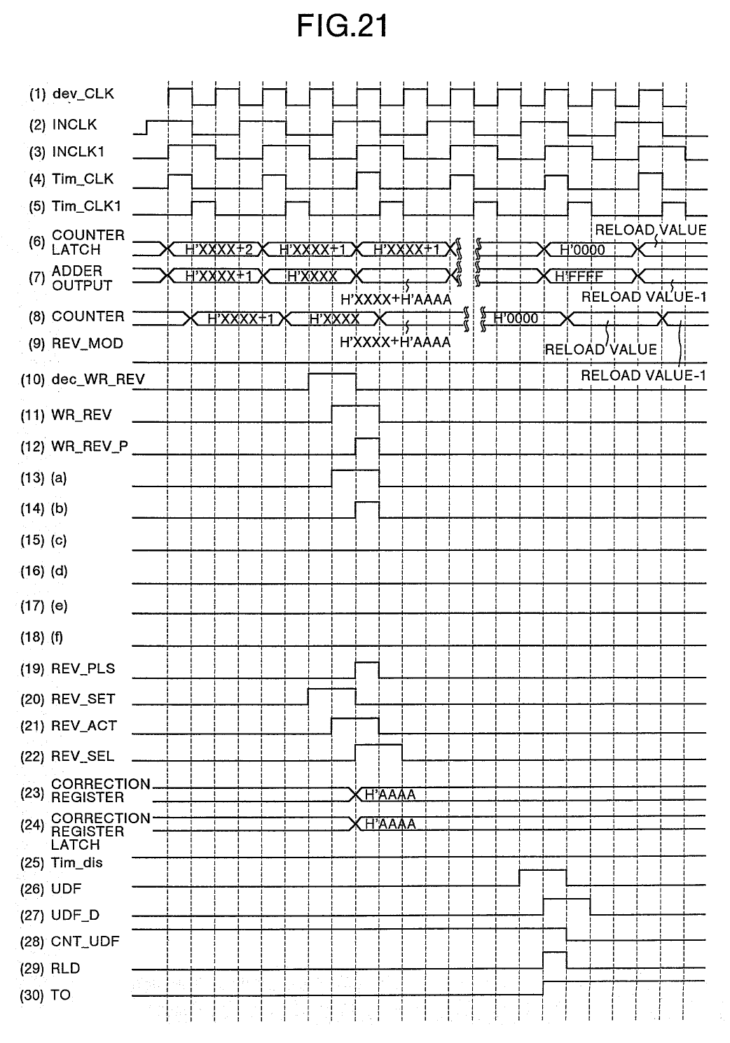

FIG. 20 is a time chart for explaining a correction operation of a count period when both an effective period assign signal REV_MOD and a counter status signal CNT_UDF are at the “H” level, and a correction execution post signal dec_WR_REV and a source count clock INCLK1 overlap with each other. FIG. 21 is a time chart for explaining a correction operation of a count period when both an effective period assign signal REV_MOD and a counter status signal CNT_UDF are at the “H” level, and a correction execution post signal dec_WR_REV and a source count clock INCLK1 do not overlap with each other.

FIG. 20 and FIG. 21 show that the correction of a count period based on the set value of the reload register 106 is effective, as the effective period assign signal REV_MOD (9) is at the “H” level at the generation timing of the correction execution post signal dec_WR_REV (10). Further, FIG. 20 and FIG. 21 show that the counter 116 is in the counter operation status based on the set value of the reload register 106, as the counter status signal CNT_UDF is at the “H” level at the generation timing of the correction execution post signal dec_WR_REV (10).

The count period indicated by the effective period assign signal REV_MOD coincides with the counter operation status shown by the counter status signal CNT_UDF. Therefore, after the generation of the correction execution post signal dec_WR_REV (10), the control signal WR_REV (11) and the write signal WR_REV_P (12) are generated, and the writing to the correction register 102 is executed (23). Then, after the generation of the correction execution post signal dec_WR_REV (10), the output (a) of the F/F 43 is generated (13), and the output (b) of the AND gate 48 is generated (14).

In the case shown in FIG. 20, the read signal REV_PLS (19) and the control signal REV_SET (20) are generated at the same time, and first, the setting (24) to the correction register latch 108 is carried out. Thereafter, the correction execute signal REV_ACT (21) and the select signal REV_SEL (22) are generated sequentially. As a result, the correction of the count period is executed based on the set value of the reload register 106.

In the case shown in FIG. 21, the control signal REV_SET (20) is generated in simultaneous with the generation of the correction execution post signal dec_WR_REV (10). Thereafter, the correction execute signal REV_ACT (21) and the select signal REV_SEL (22) are generated sequentially. The read signal REV_PLS (19) is generated at a timing when the correction execute signal REV_ACT (21) and the select signal REV_SEL (22) overlap with each other. Based on this, the setting (24) to the correction register latch 108 and the inputting of this set value to the adder circuit 110 are executed at the same time. As a result, the correction of the count period is executed based on the set value of the reload register 106.

As explained above, according to the second embodiment, when the correction-intended count period is the count period based on the set value of the reload register 106, and when the counter 116 is in the count operating status based on the set value of the counter WR buffer 104, the counter 116 can execute the correction of the count period based on the set value of the reload register 106 by waiting until the count operation status has shifted to the count operation based on the set value of the reload register 106.

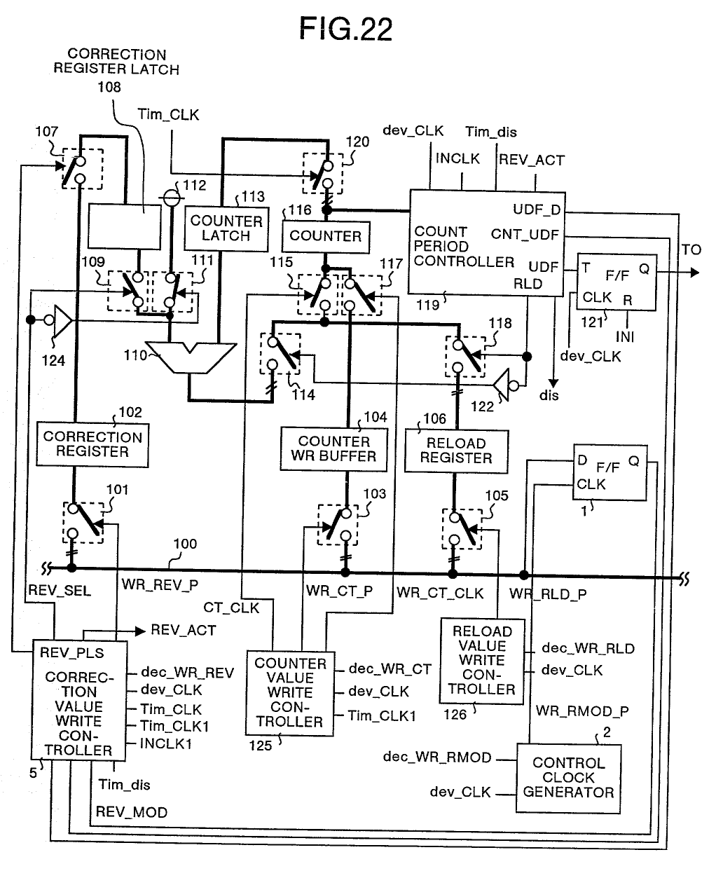

FIG. 22 is a block diagram showing a structure of a timer circuit according to a third embodiment of the present invention. As shown in FIG. 22, the timer circuit according to the third embodiment has a correction value write controller 5 in place of the correction value write controller 4 in the second embodiment (FIG. 12). The rest of the structure is similar to that of the second embodiment (FIG. 12).

The third embodiment relates to a case of correcting both a set value (hereinafter to be referred to as a “counter value”) of a counter WR buffer 104 set at the beginning and a set value (hereinafter to be referred to as a “reload value”) of a reload register 106. In this case, the third embodiment makes it possible to control such that both set values are corrected or neither of the set values is corrected, by avoiding the correction of only one value (the reload value) because of a timing.

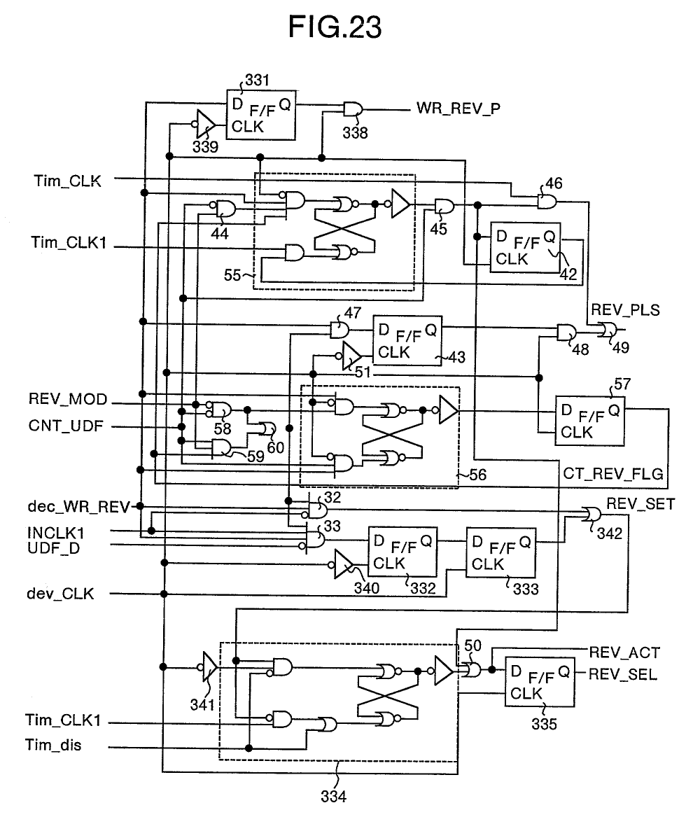

FIG. 23 shows a detailed structure example of the correction value write controller 5. As shown in FIG. 23, for carrying out the correction of a count period in the reload value, there is a new additional limit condition that the correction of a count period in the counter value has been executed. The correction value write controller 4 in FIG. 23 has an F/F 55 in place of the F/F 41, and also has additionally F/Fs 56 and 57, AND gates 58 and 59, and an OR gate 60, in FIG. 13.

In FIG. 23, the AND gate 58 sets the “H” level to the output to the OR gate 60 and the F/F 56, when an effective period assign signal REV_MOD and a counter status signal CNT_UDF are both at the “L” level. The AND gate 59 sets the “H” level to the output to the OR gate 60, when the effective period assign signal REV_MOD and the counter status signal CNT_UDF are both at the “H” level and also when the output (CT_REV_FLG) of the F/F 57 is at the “H” level. The OR gate 60 applies the outputs of AND gates 336 and 337 to AND gates 47 and 32.

The set conditions of the F/F 56 are that the output of the AND gate 58 is at the “H” level, an operation clock dev_CLK is at the “L” level, and a correction execution post signal dec_WR_REV has been generated. The reset conditions of the F/F 56 are that the operation clock dev_CLK is at the “L” level, a counter status signal CNT_UDF is at the “H” level, and the correction execution post signal dec_WR_REV has been generated. The F/F 57 is input with an output of the F/F 56 at a data input terminal D, and is also input with an operation clock dev_CLK at a clock input terminal CLK. The F/F 57 outputs a control signal CT_REV_FLG from an output terminal Q. The reset conditions of the F/F 55 are the same as those of the F/F shown in FIG. 13. However, the set condition of the F/F 55 has an additional condition of the output (CT_REV_FLG) of the F/F 57.

Next, the operation of the portions relating to the third embodiment will be explained with reference to FIG. 23. As described above, when the correction execution post signal dec_WR_REV has been generated when the effective period assign signal REV_MOD and the counter status signal CNT_UDF are both at the “L” level, the correction based on the counter value is executed. Therefore, the F/F56 detects a fact that this correction has been executed, and stores this fact.

In other words, when the correction execution post signal dec_WR_REV has been generated when the effective period assign signal REV_MOD and the counter status signal CNT_UDF are both at the “L” level, the F/F sets the output to the “H” level in synchronism with the “H” timing of the operation clock dev_CLK, and holds this output level. When the F/F 56 has made the output to the “H” level, the F/F 57 outputs the control signal CT_REV_FLG. When the F/F 57 has generated the control signal CT_REV_FLG, the counter status signal CNT_UDF becomes at the “H” level, and then the correction execution post signal dec_WR_REV is generated. After the correction execution post signal dec_WR_REV has been generated, the F/F 56 is reset in synchronism with the “L” timing of the operation clock dev_CLK, and the F/F 56 sets the output to the “L” level.

Therefore, the control signal CT_REV_FLG is a signal that becomes at the “H” level during the period from when the F/F 56 is set till when the F/F 56 is reset. When the correction execution post signal dec_WR_REV has been generated after the counter status signal CNT_UDF has become at the “H” level, the correction based on the reload value is executed. Therefore, the control signal CT_REV_FLG is kept at the “H” level until when the correction based on the reload value has occurred. When the effective period assign signal REV_MOD has become at the “H” level, that is, when the correction request based on the reload value has occurred, during the period while the counter status signal CNT_UDF is at the “L” level, the F/F 55 is set immediately. The F/F 55 sets the output to the “H” level and holds this output level, as the control signal CT_REV_FLG is already at the “H” level.

Then, the OR gate 49 generates the read signal REV_PLS, the OR gate 50 generates the correction execute signal REV_ACT, and the F/F 335 outputs the REV_SET. Then, the correction of the count period based on the reload value is executed.

As explained above, according to the third embodiment, the fact of the execution of the correction of the count period based on the first counter value is stored. Then, the correction of the count period based on the reload value is executed subject to this condition. Therefore, when it is necessary to execute both the correction of the count period based on the count value and the correction of the count period based on the reload value, it is possible to securely execute both corrections.

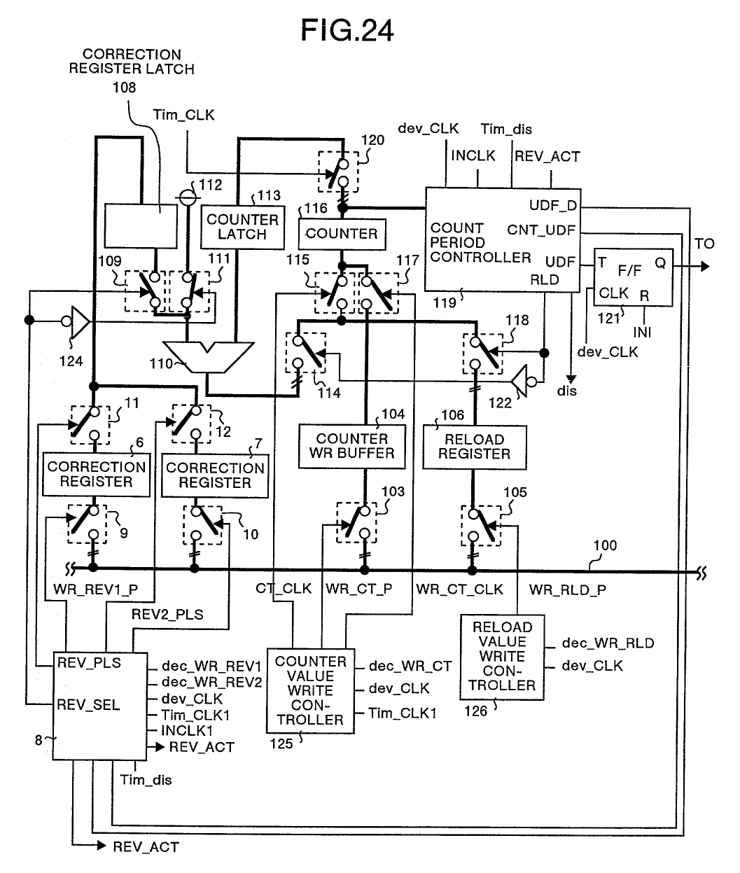

FIG. 24 is a block diagram showing a structure of a timer circuit according to a fourth embodiment of the present invention. The fourth embodiment shows another structure example of a timer circuit for realizing a correction function similar to that of the timer circuit according to the first embodiment.

As shown in FIG. 24, the timer circuit according to the fourth embodiment has two correction registers 6 and 7 in place of the correction timing register 1 and the control clock generator 2 in the timer circuit shown in FIG. 1, for realizing a similar function. Further, the timer circuit according to the fourth embodiment has correction value write controller 8 in place of the correction value write controller 3.

The correction register 6 is connected to a data bus 100 via a SW 9, and a correction register 7 is connected to the data bus 100 via a SW 10. An output of the correction register 6 is input to a correction register latch 108 via a SW 11. Similarly, an output of the correction register 7 is input to the correction register latch 108 via a SW 12. However, the correction value write controller 8 carries out the ON/OFF control of the SW 11 and SW 12 in a similar manner to that of the second and third embodiments.

The correction value write controller 8 uses the control signal UDF_D and the counter status signal CNT_UDF that have conventionally been used inside the count period controller 119, like in the first embodiment. Further, the operation clock dev_CLK, the timer clock Tim_CLK1, the source count clock CLK1, and the timer stop signal Tim_dis are input similarly.

The correction value write controller 8 is input with two signals of a correction execution post signal dec_WR_REV1 and a correction execution post signal dec_WR_REV2, in place of the correction execution post signal dec_WR_REV so far explained. The correction execution post signal dec_WR_REV1 is a signal for requesting a correction based on the counter value by making a request for writing to the correction register 6. The correction execution post signal dec_WR_REV2 is a signal for requesting a correction based on the reload value by making a request for writing to the correction register 7. In other words, a correction value for correcting a count period based on the counter value is written into the correction register 6. Further, a correction value for correcting a count period based on the reload value is written into the correction register 7.

Upon receiving these inputs, the correction value write controller 8 generates two write signals of WR_REV1_P and WR_REV1_P for ON/OFF controlling the two SWs 9 and 10, two read signals REV1_PLS and REV1_PLS for ON/OFF controlling the two SWs 11 and 12, and the select signal REV_SEL and the control signal REV_ACT explained so far respectively.

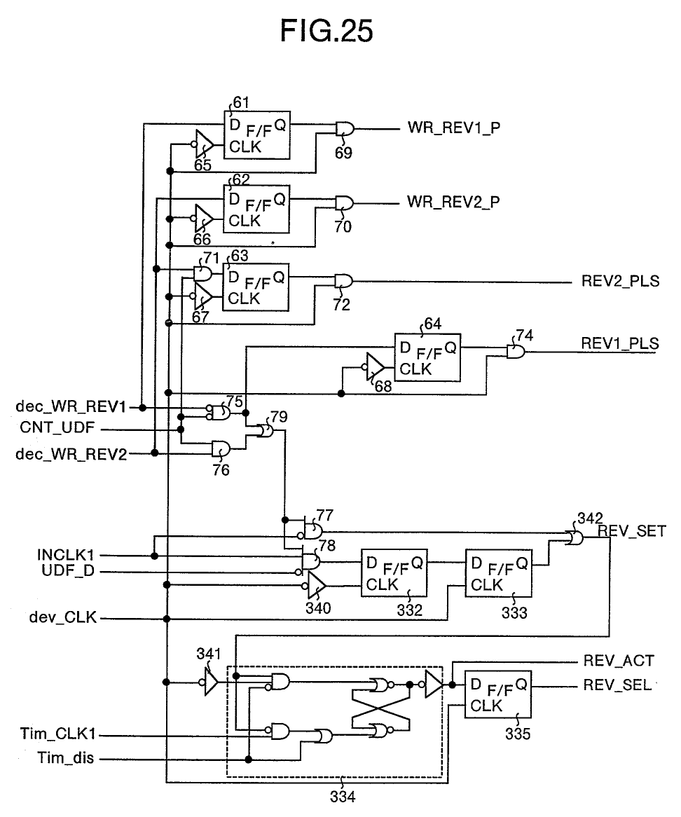

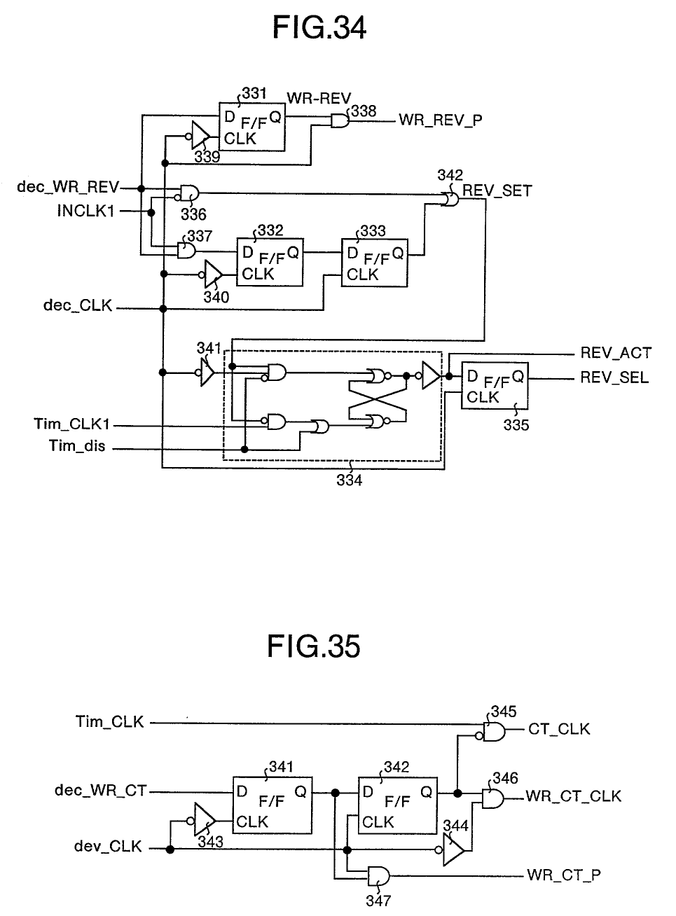

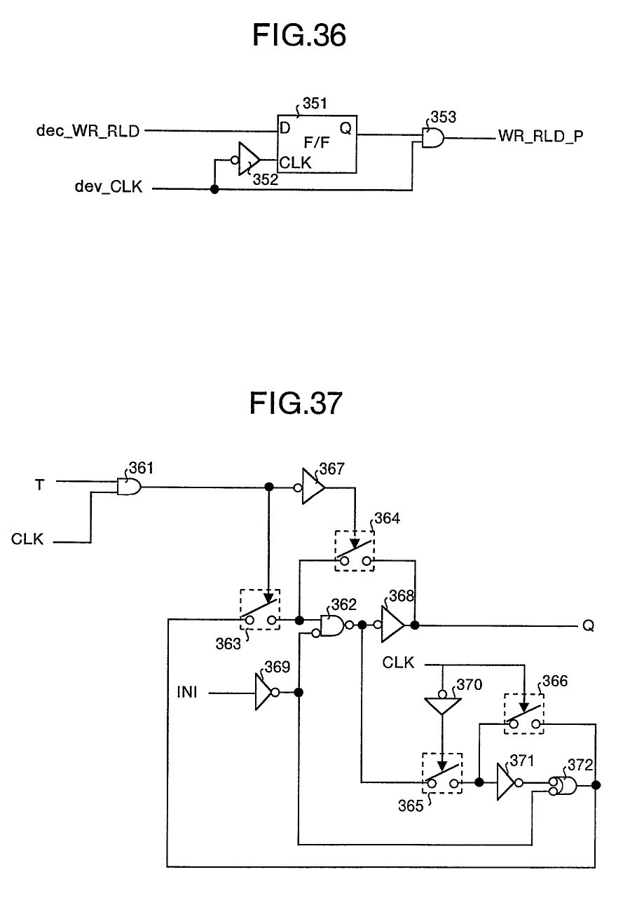

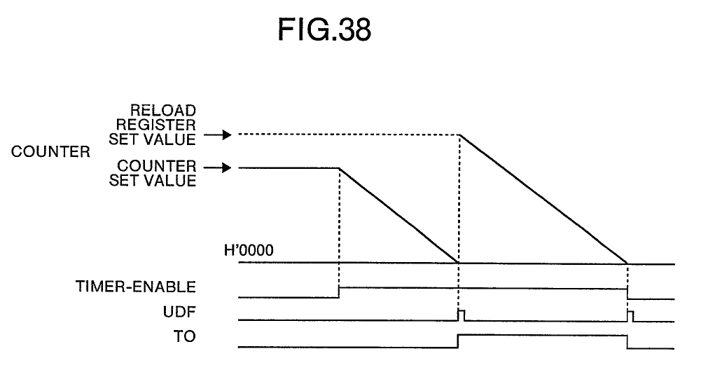

FIG. 25 shows an example of structure of the correction value write controller 8. As shown in FIG. 25, a correction control signal REV_ACT and a select signal REV_SEL are generated in a process similar to that of the first to third embodiments. However, a control signal REV_SET is generated in a process different from that of the first to third embodiments. In FIG. 25, portions having functions similar to those of the correction value write controller 123 shown in FIG. 34 are attached with like reference numbers.

In FIG. 25, the correction value write controller 8 has F/Fs 61, 62, 63, 64, 332, 333, 334 and 335, inverters 65, 66, 67, 68 and 341, AND gates 69, 70, 71, 72, 73, 74, 75, 76, 77 and 78, and OR gates 79 and 342.

The F/F 61 is input with a correction execution post signal dec_WR_REV1 for posting a write occurrence to the correction register 6 at a data input terminal D, and is also input with an operation clock dev_CLK at a clock input terminal CLK via the inverter 65. The F/F 61 outputs the correction execution post signal dec_WR_REV1 from an output terminal Q to the AND gate 69 in synchronism with the “L” timing of the operation clock dev_CLK. The AND gate 69 generates an output of the F/F 61 as a write signal WR_REV1_P in synchronism with the operation clock dev_CLK. When the write signal WR_RFV1_P has been generated, the SW 9 in FIG. 24 carries out the ON operation, and a correction value for correcting the count period based on the counter value is read from the data bus 100, and is written into the correction register 6.

The F/F 62 is input with a correction execution post signal dec_WR_REV2 for posting a write occurrence to the correction register 7 at a data input terminal D, and is also input with an operation clock dev_CLK at a clock input terminal CLK via the inverter 66. The F/F 62 outputs the correction execution post signal dec_WR_REV2 from an output terminal Q to the AND gate 70 in synchronism with the “L” timing of the operation clock dev_CLK. The AND gate 70 generates an output of the F/F 62 as a write signal WR_REV2_P in synchronism with the “H” timing of the operation clock dev_CLK. When the write signal WR_REV2_P has been generated, the SW 10 in FIG. 24 carries out the ON operation, and a correction value for correcting the count period based on the reload value is read from the data bus 100, and is written into the correction register 7.

When the correction execution post signal dec_WR_REV2 has been generated when the counter status signal CNT_UDF is at the “H” level, the AND gate 71 sets the output to the “H” level. The F/F 63 is input with an output of the AND gate 71 at a data input terminal D, and is also input with an operation clock dev_CLK at a clock input terminal CLK via the inverter 67. The F/F 63 generates an output of the AND gate 71 from an output terminal Q to the AND gate 72 in synchronism with the “L” timing of the operation clock dev_CLK. The AND gate 72 generates an output of the F/F 63 as a read signal REV2_PLS in synchronism with the “H” timing of the operation clock dev_CLK. When the read signal REV2_PLS has been generated, the SW 12 in FIG. 24 carries out the ON operation, and a correction value for correcting the count period based on the reload value of the correction register 7 is read into the correction register latch 108.

When the counter status signal CNT_UDF is at the “L” level and when a correction execution post signal dec_WR_REV1 is at the “L” level after the generation of this signal, the AND gate 75 sets the output to the OR gate 79 to the “H” level. When the correction execution post signal dec_WR_REV2 has been generated and the counter status signal CNT_UDF is at the “H” level, the AND gate 76 sets the output to the OR gate 79 to the “H” level. The F/F 64 is input with an output of the AND gate 75 at a data input terminal D, and is also input with an operation clock dev_CLK at a clock input terminal CLK via the inverter 68. The F/F 64 generates an output of the AND gate 75 from an output terminal Q to the AND gate 74 in synchronism with the “L” timing of the operation clock dev_CLK. The AND gate 74 generates an output of the F/F 64 as a read signal REV1_PLS in synchronism with the “H” timing of the operation clock dev_CLK. When the read signal REV1_PLS has been generated, the SW 11 in FIG. 24 carries out the ON operation, and a correction value for correcting the count period based on the counter value of the correction register 6 is read into the correction register latch 108.

When the output of the OR gate 79 is at the “H” level during a period while the source count clock INCLK1 is at the “L” level, the AND gate 77 sets the output to the OR gate 342 to the “H” level. When the output of the OR gate 79 is at the “H” level and also the control signal CNT_D is at the “L” level during a period while the source count clock INCLK1 is at the “H” level, the AND gate 78 sets the output to the “H” level. The F/F 332 is input with an output of the AND gate 78 at a data input terminal D, and is also input with an operation clock dev_CLK at a clock input terminal CLK via the inverter 340. The F/F 332 generates an output of the AND gate 78 from an output terminal Q to a data input terminal D of the F/F 333 in synchronism with the “L” timing of the operation clock dev_CLK.

The F/F 333 is input with an output of the F/F 332 at a clock input terminal CLK via the inverter 340, and generates an output of the F/F 332 from an output terminal Q to the OR gate 342 in synchronism with the “H” timing of the operation clock dev_CLK. Thus, the OR gate 342 generates a control signal REV_SET. Based on this, a correction execute signal REV_ACT, and a selection signal REV_SEL are generated sequentially.

In the above structure, according to the fourth embodiment, when correction requests have been generated, the correction value write controller 8 executes the correction only when the count period and the operation status of the counter 116 coincide with each other in the respective correction requests.

In other words, when there has been a write request to the correction register 6 by the correction execution post signal dec_WR_REV1, that is, when there has been a correction request for correcting the count period based on the counter value, the AND gate 69 generates the write signal WR_REV1_P. Then, the SW9 carries out the ON operation, and the correction value for the count period based on the counter value is read from the databus 100, and the correction value is written into the correction register 6. Then, only when it has been detected that the counter status signal CNT_UDF is at the “L” level in the AND gate 75, the AND gate 74 generates the read signal REV1_PLS to the correction register latch 108. Further, the OR gate 342 generates the REV_SET for controlling the input to the adder circuit 110. As a result, the correction of the count period based on the counter value is executed.

When there has been a write request to the correction register 7 by the correction execution post signal dec_WR_REV2, that is, when there has been a correction request for correcting the count period based on the reload value, the AND gate 70 generates the write signal WR_REV2_P. Then, the SW 10 carries out the ON operation, and the correction value for the count period based on the reload value is read from the data bus 100, and the correction value is written into the correction register 7. Then, only when it has been detected that the counter status signal CNT_UDF is at the “H” level in the AND gates 71 and 76, the AND gate 72 generates the read signal REV2_PLS to the correction register latch 108. Further, the OR gate 342 generates the REV_SET for controlling the input to the adder circuit 110. As a result, the correction of the count period based on the reload value is executed.

In the first embodiment, the correction timing register 1 is used to control the correction of the count period based on the counter value and the correction of the count period based on the reload value, by discriminating between the two. On the other hand, according to the fourth embodiment, as explained above, the correction register 6 for storing the correction value for the count period based on the counter value and the correction register 7 for storing the correction value for the count period based on the reload value are prepared separately, in place of the above correction timing register 1. Based on this, the read timing of reading into the correction register latch 108 is similar to that of the second embodiment, and it is possible to carry out the correction operation similar to that of the first embodiment. The correction registers 6 and 7 do not need to be physically separate storage units. In stead, one storage unit may be used to store both correction values in a state that they can be discriminated.

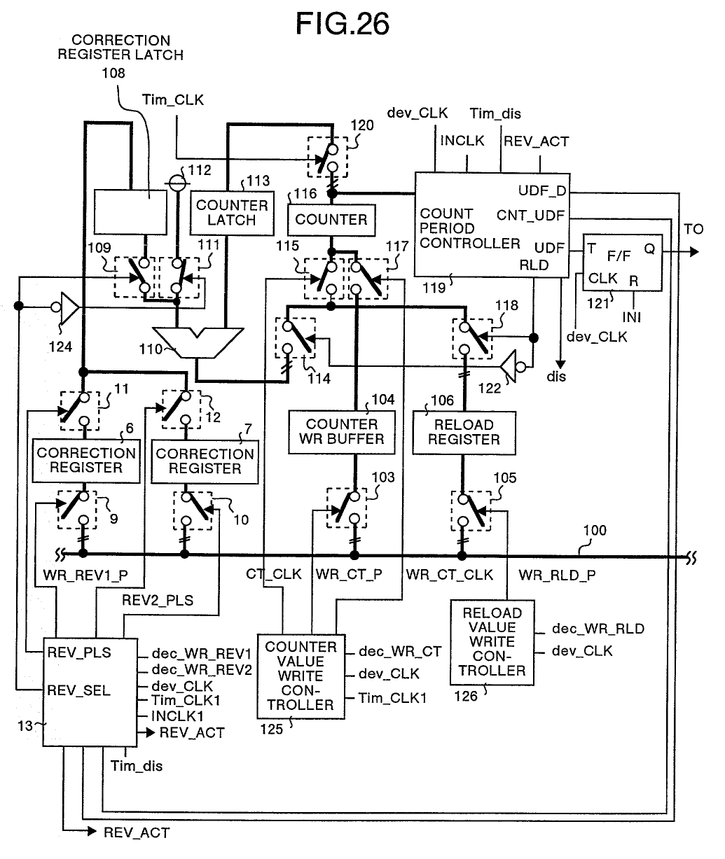

FIG. 26 is a block diagram showing a structure of a timer circuit according to a fifth embodiment of the present invention. The fifth embodiment shows another structure example of a timer circuit for realizing a correction function similar to that of the timer circuit according to the second embodiment. As shown in FIG. 26, the timer circuit according to the fifth embodiment has a correction value write controller 13 in place of the correction value write controller 8 in the fourth embodiment (FIG. 24).

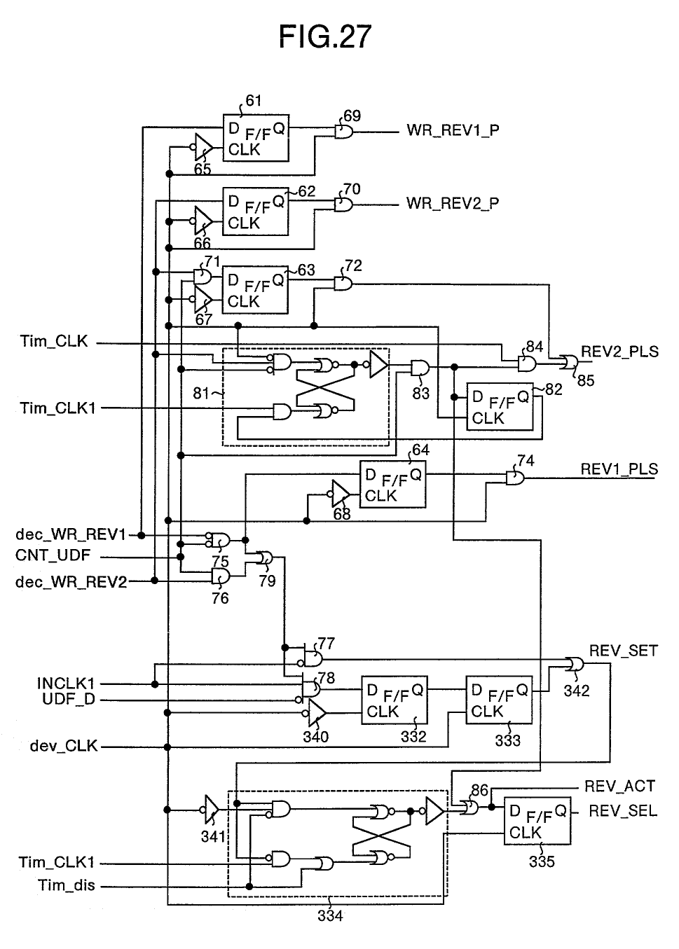

The correction value write controller 13 has a structure as shown in FIG. 27, for example. FIG. 27 shows portions relating to the fifth embodiment in addition to the structure shown in FIG. 25. In other words, in FIG. 27, the correction value write controller 13 has an addition of F/Fs 81 and 82, AND gates 83 and 84, and OR gates 85 and 86.

In FIG. 27, the set conditions of the F/F 81 are that an operation clock dev_CLK is during the “L” level period, a correction execution post signal dec_WR_REV2 of the count period based on the reload value has been generated, and a counter status signal CNT_UDF is at the “L” level. The AND gate 83 is input with an output of the F/F 81 and the counter status signal CNT_UDF. The AND gate 84 is input with a timer clock Tim_CLK and an output of the AND gate 83. The OR gate 85 is input with an output of the AND gate 84 and an output of the AND gate 75. The OR gate 85 generates a read signal REV2_PLS.

The OR gate 86 is input with an output of an F/F 334 and an output of the AND gate 83, and generates a correction execute signal REV_ACT as an input to an F/F 335. The F/F 82 is input with an output of the AND gate 83 at a data input terminal D, and is also input with an operation clock dev_CLK at a clock input terminal CLK. The F/F 81 is input with a timer clock Tim_CLK1 and an output of the F/F 82 as reset signals.

In the above structure, according to the fifth embodiment, when correction requests have been generated, the correction value write controller 13 executes the correction only when the count period and the operation status of the counter 116 coincide with each other in the respective correction requests, like in the fourth embodiment.

Specifically, when the counter status signal CNT_UDF is at the “L” level when the correction value has been written into the correction register 6 based on the generation of the correction execution post signal dec_WR_REV1, the correction of the count period based on the counter value is executed according to the correction request. When the counter status signal CNT_UDF is at the “H” level when the correction value has been written into the correction register 7 based on the generation of the correction execution post signal dec_WR_REV2, the correction of the count period based on the reload value is executed according to the correction request.

According to the fifth embodiment, when the count period and the operation status of the counter 116 do not coincide with each other in the respective correction requests, the correction of the count period based on the reload value requested by the correction execution post signal dec_WR_REV2 is executed by waiting until the counter status signal CNT_UDF has become at the “H” level, like in the second embodiment, when the counter status signal CNT_UDF is at the “L” level when the correction execution post signal dec_WR_REV2 for requesting the correction of the count period based on the reload value has been generated.

In other words, when the counter status signal CNT_UDF is at the “L” level when the correction execution post signal dec_WR_REV2 for requesting the correction of the count period based on the reload value has been generated, the F/F 81 is set in synchronism with the “L” timing of the operation clock dev_CLK, and the output to the AND gate 83 is held at the “H” level. Thereafter, the AND gate 83 sets the output to the “H” level in synchronism with a change of the counter status signal CNT_UDF from the “L” level to the “H” level. When the output of the AND gate 83 has become at the “H” level, the AND gate 84 generates an output to the OR gate 85 in synchronism with the timer clock Tim_CLK, and the OR gate 85 outputs the read signal REV2_PLS. When the output of the AND gate 83 has become at the “H” level, the output is read into the F/F 82 in synchronism with the operation clock dev_CLK. The F/F 81 is reset based on the output of the F/F 82.

Then, the SW 12 in FIG. 26 carries out the ON operation, and the correction value for the count period based on the reload value is read from the correction register 7, and is set to the correction register latch 108. An output of the AND gate 83 is generated as the correction execute signal REV_ACT via the OR gate 86, and the select signal REV_SEL is generated. Then, the SW 109 carries out the ON operation, and the correction value of the correction register latch 108 is read into the adder circuit 110. As a result, the correction of the count period based on the reload value is executed.

As explained above, according to the fifth embodiment, when the correction-intended count period is the count period based on the reload value, and when the counter is carrying out the count operation based on the counter value, it is possible to execute the correction by waiting until the counter has shifted to the count operation based on the reload value.

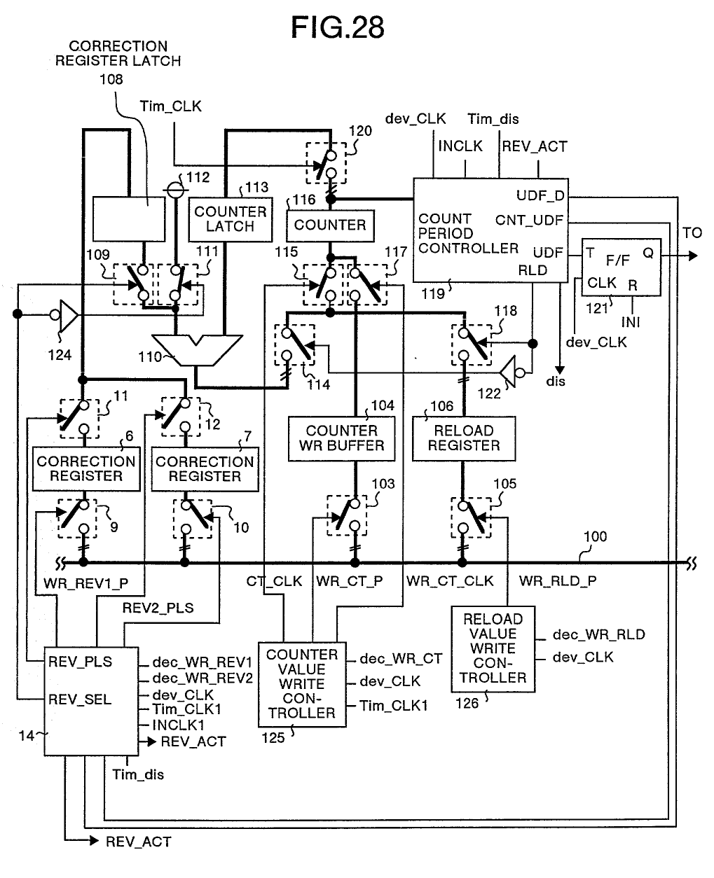

FIG. 28 is a block diagram showing a structure of a timer circuit according to a sixth embodiment of the present invention. The sixth embodiment shows another structure example of a timer circuit for realizing a correction function similar to that of the timer circuit according to the third embodiment. As shown in FIG. 28, the timer circuit according to the sixth embodiment has a correction value write controller 14 in place of the correction value write controller 13 in the fifth embodiment (FIG. 26).

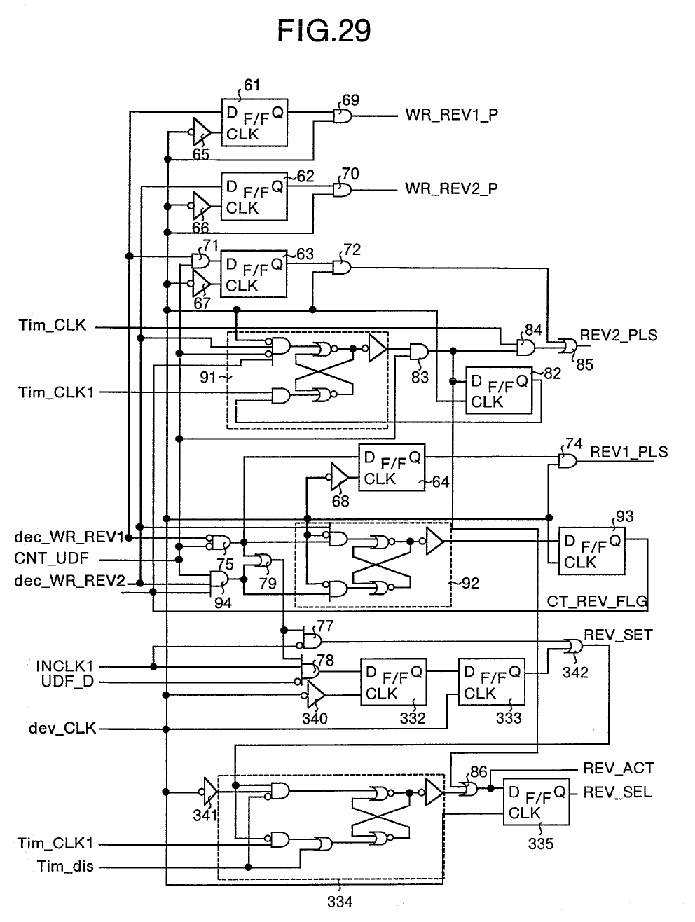

The correction value write controller 14 has a structure as shown in FIG. 29, for example. FIG. 29 shows portions relating to the sixth embodiment in addition to the structure shown in FIG. 27. In other words, in FIG. 29, the correction value write controller 14 has an addition of an F/F 91 in place of the F/F 81, F/Fs 92 and 93, and. an AND gate 94 in place of the AND gate 76.

In FIG. 29, the set conditions of the F/F 91 are that an operation clock dev_CLK is during the “L” level period, a correction execution post signal dec_WR_REV2 of the count period based on the reload value has been generated, a counter status signal CNT_UDF is at the “L” level, and an output (CT_REV_FLG) of the F/F 93 is at the “H” level. The reset conditions are similar to those of the F/F 81. The AND gate 94 that replaces the AND gate 76 is input with the output (CT_REV_FLG) of the F/F93, in addition to the counter status signal CNT_UDF and the correction execution post signal dec_WR_REV2.

The set conditions of the F/F 92 are that a correction execution post signal dec_WR_REV2 has been generated, an operation clock dev_CLK is during the “L” level period, and an output of the AND gate 75 is at the “H” level. The reset conditions are that an operation clock dev_CLK is during the “L” level period, and an output of the AND gate 94 is at the “H” level. The F/F 93 is input with an output of the F/F 92 at a data input terminal D, and is input with an operation clock dev_CLK at a clock input terminal CLK. The F/F 93 outputs a control signal CT_REV_FLG from an output terminal Q in synchronism with the “H” timing of the operation clock dev_CLK.

Next, the operation of portions relating to the sixth embodiment will be explained with reference to FIG. 29. As explained above, when the correction execution post signal dec_WR_REV1 for requesting the correction of the count period based on the counter value has been generated when the counter status signal CNT_UDF is at the “L” level, the correction based on the counter value is executed. Therefore, the F/F 92 detects the fact that this correction has been executed, and stores this fact.

In other words, when the counter status signal CNT_UDF is at the “L” level after the correction execution post signal dec_WR_REV1 has become at the “L” level, and when the correction execution post signal dec_WR_REV2 has been generated, the F/F 92 sets the output to the “H” level in synchronism with the “H” timing of the operation clock dev_CLK, and holds this output level. When the F/F 92 has set the output to the “H” level, the F/F 93 outputs the control signal CT_REV_FLG. When the correction execution post signal dec_WR_REV2 has been generated after the counter status signal CNT_UDF has become at the “H” level since the F/F 93 has generated the control signal CT_REV_FLG, the F/F 92 is reset in synchronism with the “L” timing of the operation clock dev_CLK, and the F/F 92 sets the output to the “L” level.

Therefore, the control signal CT_REV_FLG is a signal that becomes at the “H” level during a period from when the F/F 92 has been set till when the F/F 92 is reset. When the correction execution post signal dec_WR_REV2 has been generated after the counter status signal CNT_UDF has become at the “H” level, the correction based on the reload value is executed. Therefore, the control signal CT_REV_FLG is at the “H” level until when the correction based on the reload value has occurred. When the correction execution post signal dec_WR_REV2 for requesting the correction based on the reload value has been generated when the counter status signal CNT_UDF is at the “L” level, the F/F 91 is set immediately, as the control signal CT_REV_FLG has already been at the “H” level. Then, the F/F 91 sets the output to the “H” level, and holds this output level.

Then, the OR gate 49 generates the read signal REV2_PLS, the OR gate 86 generates the correction execute signal REV_ACT, and the F/F 335 outputs the REV_SET. Then, the correction of the count period based on the reload value is executed.

As explained above, like in the third embodiment, according to the sixth embodiment, the fact of the execution of the correction of the count period based on the first count value is stored. Then, the correction of the count period based on the reload value is executed subject to this condition. Therefore, when it is necessary to execute both the correction of the count period based on the count value and the correction of the count period based on the reload value, it is possible to securely execute both corrections.

As explained above, according to one aspect of this invention, there is provided a setting unit which sets a correction-intended count period. When the correction-intended count period that has been assigned by this setting unit coincides with the count period during which the counter is carrying out the count operation, the correction value according to the correction request can be set to the counter. Therefore, there is an effect that it is possible to easily and securely correct the desired count period. In this case, it is possible to use the originally existing control signals for setting the correction-intended count period and for making a decision about whether the counter is currently carrying out the count operation during the first count period or during the second count period. Therefore, it is not necessary to carry out additional operation or processing like the checking of the counter operation status by operating the switch circuit for changing over the data path. Thus, there is also an effect that it is possible to substantially reduce the load of the switch circuit.

Furthermore, when the correction-intended count period is the second count period after the first count period during which the counter is currently carrying out the count operation, it is possible to execute the correction during the second count period by waiting until the counter has shifted the count operation to the second count period. Therefore, even when the correction-intended count period does not coincide with the count period during which the counter is carrying out the count operation, there is an effect that it is possible to execute the correction of the correction-intended count period.

Furthermore, it is possible to store a fact about whether the correction has been executed during the first count period or not. When it is possible to immediately execute the correction during the second count period, the correction is executed during the second count period subject to the condition that the correction has been executed during the first count period. Therefore, when the correction is to be carried out during both count periods instead of during either the first count period or the second count period, there is an effect that it is possible to execute the correction during both count periods continuously.

Further, according to another aspect of this invention, a correction request for the first count period and a correction request for the second count request are generated separately as correction requests. The storage unit is provided into which a correction value for the first count period and a correction value for the second count period are written upon reception of the respective correction requests. When the count period corresponding to the correction request coincides with the count period during which the counter is carrying out the count operation, it is possible to set to the counter the correction value for the count period corresponding to this correction request. Therefore, there is an effect that it is possible to execute easily and securely the correction of the correction-intended count period. In this case, it is possible to use the originally existing control signal for making a decision about whether the counter is currently carrying out the count operation during the first count period or during the second count period. Therefore, it is not necessary to carry out additional operation or processing like the checking of the counter operation status by operating the switch circuit for changing over the data path. Thus, there is also an effect that it is possible to substantially reduce the load of the switch circuit.

Furthermore, when the count period corresponding to the correction request is the second count period after the first count period during which the counter is currently carrying out the count operation, it is possible to execute the correction during the second count period by waiting until the counter has shifted the count operation to the second count period. Therefore, even when the count period corresponding to the correction request does not coincide with the count period during which the counter is carrying out the count operation, there is an effect that it is possible to execute the correction of the correction-intended count period.

Furthermore, it is possible to store a fact about whether the correction has been executed during the first count period or not. When it is possible to immediately execute the correction during the second count period, the correction is executed during the second count period subject to the condition that the correction has been executed during the first count period. Therefore, when the correction is to be carried out during both count periods instead of during either the first count period or the second count period, there is an effect that it is possible to execute the correction during both count periods continuously.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A timer circuit comprising:
a counter which sequentially carries out a count operation during a first count period and a subsequent second count period;
a deciding unit which detects completion of the count operation during the first count period and thereby makes a decision about whether said counter is currently carrying out the count operation during the first count period or during the second count period;
a setting unit which sets a correction-intended count period;
a storage unit which stores a correction value based on generation of a correction request; and
a count period correcting unit which decides whether the count period decided by said deciding unit coincides with the count period set by said setting unit, upon receiving the generation of the correction request, and makes the counter execute the count operation based on the correction value when both count periods coincide with each other.

2. The timer circuit according to claim 1, wherein
if the count period decided by said deciding unit is the first count period and the count period set by said setting unit is the second count period, said count period correcting unit waits until said deciding unit has decided the second count period, and makes said counter execute the count operation based on the correction value when both count periods have coincided with each other.

3. The timer circuit according to claim 1, wherein
said count period correcting unit stores data regarding whether the correction is to be performed during the first count period, and refers to the stored data and when the correction has been executed during the first count period, makes said counter execute the count operation based on the correction value during the second count period, when the count period set by said setting unit and the count period decided by said deciding unit are both the second count period.

4. A timer circuit comprising:
a counter which sequentially carries out a count operation during a first count period and a subsequent second count period;
a deciding unit which detects completion of the count operation during the first count period and thereby makes a decision about whether said counter is currently carrying out the count operation during the first count period or during the second count period;
a storage unit which stores a correction value for the first count period and a correction value for the second count period upon reception of corresponding correction requests respectively; and
a count period correcting unit which decides whether the count period corresponding to a correction request coincides with the count period decided by said deciding unit, upon receiving the generation of the correction request, and makes said counter execute the count operation based on the correction value for the corresponding count period written in said storage unit when both count periods coincide with each other.

5. The timer circuit according to claim 4, wherein
if the count period decided by said deciding unit is the first count period and the count period set by said setting unit is the second count period, said count period correcting unit waits until said deciding unit has decided the second count period, and makes said counter execute the count operation based on the correction value when both count periods have coincided with each other.

6. The timer circuit according to claim 4, wherein said count period correcting unit stores data regarding whether the correction is to be performed during the first count period, and refers to the stored contents and when the correction has been executed during the first count period, makes said counter execute the count operation based on the correction value for the second count period stored in said storage unit during the second count period, when the count period corresponding to the correction request and the count period decided by said deciding unit are both the second count period.
